(19) United States
(12) Patent Application Publication
(10) Pub. No.: US 2005/0114415 A1
(43) Pub. Date: May 26, 2005

(54) Low-latency circular priority selector

(75) Inventor: Patrick W. Bosshart, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/995,776

(22) Filed: Nov. 23, 2004

Related U.S. Application Data
(60) Provisional application No. 60/524,565, filed on Nov. 24, 2003.

(51) Int. Cl. G06F 13/00

(52) U.S. Cl. 708/168

(57) ABSTRACT

A circular priority selector, which comprises an input interface (30) for receiving a first N-bit input (REQ<N−1:0>) and a second N-bit input (START<N−1:0>). The selector also comprises a binary tree (34) for searching in the first N-bit input to identify a location of a most significantly asserted value in the first N-bit input, wherein the searching commences at a location responsive to an asserted bit in the second N-bit. The selector also comprises circuitry (32₀ through 32_{N-1}), responsive to the binary tree, for outputting an output signal indicating a location of the most significantly asserted value in the first N-bit input.

### CROSS-REFERENCES TO RELATED APPLICATION

This application claims priority, under 35 U.S.C. Section 119, to provisional application U.S. Ser. No. 60/524,565, filed Nov. 24, 2003, entitled “Low-latency circular priority selector.”

### STATEMENT REGARDING FEDERALLY SPONSORED RESEARCH OR DEVELOPMENT

Not Applicable.

### BACKGROUND OF THE INVENTION

The present embodiments relate to a priority selector and are more particularly directed to a circular priority selector for use with an N-bit signal corresponding to a number of requests, where the requests are from a number of requesters or from a number of bits from which it is desired to identify a most significant bit in a circular order.

In data processing systems, often there are a number of requestors placing electronic requests for access to a resource or resources, and various techniques have been developed for arbitrating among the requests. For example, there may be numerous interrupts in a microprocessor, where each interrupt has a priority so that, at a given interrupt check time, the asserted interrupt having the highest priority gets preferential service. For this or other examples, there arises a need to prioritize the response to the various requesters.

A priority selector is a component that receives an N-bit input signal, where each bit in the signal has a fixed priority according to the significance of its bit position in the N bits. Also, each bit represents a request signal from one of various requesters, such a by way of example from various different interrupts. In response, the priority selector outputs an N-bit output signal that has a binary one located at the bit position corresponding to the bit position in the input signal that represents the most-significantly located value of one, with zeroes in all other of the N−1 bit locations. This output signal, therefore, is usable to select from the input signal only its most significant bit (“MSB”) or only its bits from the MSB downward to the least significant bit (“LSB”). This arbitration approach, however, is not always fair or optimal because each request or each bit in the input signal has a fixed position of importance among the bits from MSB to LSB. Thus, the higher priority-positioned bits are likely to receive a larger frequency of service as compared to the lower priority-positioned bits.

Another approach to priority selection and known in the art is a circular priority selector. Like the priority selector described above, an input to the circular priority selector is an N-bit signal representing requests from various requestors. However, for the circular priority selector, it receives a second N-bit input signal, containing a single one in one bit location and with zeroes in all other of the N−1 bit locations. The location of the single one in this second input is used to indicate a start bit position in the first input. Particularly, the selector searches in the first input and from a given bit position, such as that corresponding to, or relative to, where the one is located in the second input, toward the lesser significant bit positions in an effort to determine the location of the most-significantly located value of one in the first input. Thus, relative to the location of the one in the second input, the selector searches for the leading one in the first input value, and if the leading one is not found starting from the search point downward toward its physical LSB position, then the search wraps around back to the physical MSB position, ultimately terminating after a full circle has been made. In any event, once the most significantly located value of one is identified in the first input, it is indicated in an N-bit output that has a single value of one at the position identified in the first input, with the remaining bits in the output each set to zero.

By way of further background, FIG. 1 illustrates a schematic 10 of two one-bit blocks 101 and 102 implementing a portion of a prior art circular priority selector, such as introduced above. For sake of reference with respect to the two input signals discussed above, the first N-bit input signal is a REQUEST signal denoted herein as REQ<N−1:0>, the second N-bit input signal denoted herein as START<N−1:0>, and the corresponding N-bit OUTPUT signal is denoted herein OUT<N−1:0>. In general, the devices and connectivity within each block 10 are the same, with a chain of these blocks connected and also wrapping around as further appreciated in FIG. 2, below. Looking then to blocks 101 and 10₀ in connection with the input, for each block only one respective bit of the OUTPUT signal OUT<N−1:0> is provided, shown as OUT<1> and OUT<0>, respectively. Similarly, each block receives a respective REQUEST and START signal bit. However, as appreciated later, larger input and output signals may be implemented by connecting a number of copies of a block 10ₓ in a circular form.

Turning now to the devices and connectivity in block 101, bit REQ<1> is connected as an input to an AND gate 12₁, which outputs the OUTPUT signal bit OUT<1>. A second input to AND gate 121, EN<2>, is part of what will be referred to herein as an N-bit ENABLE signal produced from a preceding block (not shown), where that bit is operable to control the operation of block 10₁ as further appreciated below. The EN<2> input is also connected as an input to a second AND gate 141, which receives as a second input a bit /REQ<1>, where the “/” designation is used in this document for any signal to mean its logical complement (or inverse), so that, for example, “/signal” is the logical complement of “signal;” thus, /REQ<1> is the complement of REQ<1>. The output of AND gate 14, is connected as an input to an OR gate 16₁, which receives as a second input a bit START<1>, where it will be shown later that an asserted bit in the START signal is used to trigger a desired one of the ENABLE bits EN<x>. Further in this regard, the output of OR gate 16₁ provides an ENABLE bit EN<1>, for connecting to block 10₀, as the next block 10ₓ in a circular chain of such blocks.

As introduced above, the devices and connectivity in block 10₀ are comparable to block 10₁ and, thus, they are now reviewed in less detail as the reader is assumed familiar with the preceding. Bit REQ<0> is connected as an input to an AND gate 12₀, which outputs an OUTPUT signal bit OUT<0>. A second input to AND gate 12₀, EN<1>, is output from the preceding block, which is block 10₁ and is output by OR gate 16₁. The EN<1> input is also connected as an input to a second AND gate 14₀, which receives as a second input a bit /REQ<0>. The output of AND gate 14₀ is connected as an input to an OR gate 16₀, which receives as a second input a bit START<0>. The output of OR gate 16₀ provides an enable bit EN<0>, for connecting to a next block 10ₓ in a circular chain of such blocks, so in the present example that bit is used in a wraparound sense to a next block 10ₓ (not shown) in a circular manner, as further appreciated below.

The operation of blocks 10₁ and 10₀ is now demonstrated by a first example, leading further to an understanding of connecting them in a larger chain of blocks and in a circular fashion. Recall that the REQ<N−1:0> signal is the first input signal described above with respect to the circular priority selector as corresponding to an accumulated N-bit signal from one or more various requestors. In a first instance, assume then that REQ<1>=0 and REQ<0>=1. Similarly, recall that the START<N−1:0> signal is the second input signal described above with respect to the circular priority selector, which therefore indicates where along the selector the search for the most significant one is to be sought in the first input signal, REQ<N−1:0>. Also in the first instance, then, assume that START<1>=1 and START<0>=0. With these assumptions, the value of START<1>=1 enables the output of OR gate 16₁, thereby coupling a high value into AND gate 12₀. As a result, AND gate 12₀ passes to its output, OUT<0>, the value of REQ<0>. In the present example, REQ<0>=1 and, thus, OUT<0>=1 as well. Thus, at this point, note that a value of START<1>=1 in block 101 has caused the next block in the chain, block 10₀, to output the value of its REQ bit, namely, that of REQ<0>; moreover, because REQ<0>=1 in this case, then the first instance of a high REQUEST bit following the asserted value of START<1>=1, in terms of bit order significance, has been output by selector 10 at position OUT<0>. In addition, since REQ<0>=1, then its complement is /REQ<0>=0; this signal is connected to AND gate 14₀, thereby forcing low its output, which is connected as an input to OR gate 16₀. Further, because by definition only one bit of START<N−1:0> is high at a time, and since in the present instance START<1>=1, then START<0>=0. Thus, this low is also connected as an input to OR gate 16₀, thereby in combination with the output of AND gate 14₀ causing the output of OR gate 16₀, EN<0>, to be low. Recall that EN<0> is connected as an enable bit to a next successive block 10ₓ in the chain, and since it is low that next block will not be enabled to pass its REQ<x> bit through to its respective output OUT<x>.

The operation of blocks 10₁ and 10₀ is now further demonstrated by a second example, where in this second instance assume again START<1>=1 and START<0>=0, but assume further that REQ<1>=0 and REQ<0>=0. With these assumptions, the value of START<1>=1 again enables the EN<1> output of OR gate 16₁, thereby coupling a high value into AND gate 12₀. Again, therefore, AND gate 12₀ passes to its output, OUT<0>, the value of REQ<0>, but in the present example, REQ<0>=0 and, thus, OUT<0>=0. Thus, at this point, note that block 10₀ has been processed to determine that its REQ<0> bit is not a most significantly located value of one, relative to the asserted location of START<1>=1, because its REQUEST input, REQ<0>, is zero rather than one. Further, since /REQ<0> is input to AND gate 14₀, then this is a high value that is input to AND gate 14₀ and it AND'ed with the high value from EN<1>, thereby connecting a high value into OR gate 16₀ and asserting EN<0>. As a result, the block following block 10₀, while not shown, will be enabled to thereby determine whether that block has a high REQ<x> value for outputting. By continuing in this manner, therefore, each successive block is enabled until one in the chain is found that has a high REQ<x> value for outputting. Thus, this operation is consistent with that described earlier in general for a circular priority selector, whereby once a bit from START<N−1:0> is enabled, a search begins in REQ<N−1:0>, starting at a position relative to the position of the enabled bit START<N−1:0>, until an asserted value is found in REQ<N−1:0> continuing in a direction from a more significant bit position toward a lesser significant bit position. The search also wraps around to the physical MSB position if the search reaches the physical LSB position of REQ<N−1:0> (i.e., REQ<0>) and still does not find a respective asserted value for that LSB position.

FIG. 2 illustrates a block diagram of a prior art circular priority selector 10′ that includes blocks 10₁ and 10₀ of FIG. 1 and additional blocks to further illustrate the implementation and operation of the device. As shown in FIG. 2, a total of N blocks 10₀ through 10_{N-1} are included in selector 10′, and they are connected in a circular chain with respect to the ENABLE signal. For example, N may be 20 by way of introduction here and for sake of contrast to the preferred embodiments described later in this document. In any event, starting at a point in the circular connectivity and by way of illustration at block 10₃, block 10₃ produces a bit EN<3> of the ENABLE signal and that bit is connected as an input to block 10₂. Similarly, block 10₂ produces an ENABLE signal bit EN<2> of the ENABLE signal and that bit is connected as an input to block 10₁. This continues and, in wraparound fashion, the ENABLE signal bit EN<0> produced by block 10₀ is connected as an input to block 10_{N-1} (e.g., 10₁₉ for a 20-bit operation). The remaining signals, namely, REQ<N−1:0>, START<N−1:0>, and OUT<N−1:0> are as introduced above with respect to FIG. 1, where each bit of those signals corresponds to a respective one of the N−1 blocks 10₀ through 10_{N-1}. Thus, in the same manner as shown in FIG. 1, in FIG. 2 block 10₀ receives as inputs REQ<0> (and its complement, /REQ<0>) and START<0>, and it outputs OUT<0>. Similarly, block 10_{N-1} receives as inputs REQ<N−1> (and its complement, /REQ<N−1>) and START<N−1>, and it outputs OUT<N−1>. The remaining inputs/outputs are readily appreciable by one skilled in the art.

The operation of selector 10′ is now described and will be appreciated further in view of the earlier discussion of FIG. 1. In general, REQ<N−1> is connected to selector 10′ and represents a collection of requests to be analyzed so that a most significantly located request, which is one of the bits in REQ<N−1> that is presently asserted, may be output so that service may be given to that request. Further in this regard, only one bit START<m> in START<N−1:0> is asserted to correspondingly enable a respective enable signal EN<m>, and in response thereto so that the block 10_{m-1(mod 20)} immediately following that asserted EN<m> bit is evaluated to determine if its respective request input, REQ<m−₁(mod 20)> is high. If indeed that value of REQ<m−1(mod 20)> is high, then the corresponding output OUT<m−1(mod 20)> is high, thereby indicating that the device, interrupt, or the like corresponding to the asserted output is timely serviced; in addition, in this event, all additional ENABLE bits other that EN<m> are maintained low. However, if the value of REQ<m−₁(mod 20)> is low, then the corresponding output OUT<m−1(mod 20)> is low, and the next enable bit, EN<m−1(mod 20)>, in the direction toward lesser bit significance (unless wrapping around from the LSB to the MSB), is asserted so that the block 10ₘ₋2(mod 20), which receives that asserted ENABLE bit, then operates in the manner as did block 10_{m-3(mod 20)}, that is, to pass its input value REQ<m−2(mod 20)> to its output if that value is high, while all other lesser significant (and wrapping around) ENABLE bits are low, whereas if REQ<m−2(mod 20)> is low then output OUT<m−2(mod 20)> is also low, and a high ENABLE bit EN<m−2(mod 20)> is provided to the next successive block 10 m_{-3(mod 20)}. This process repeats, therefore, until a high bit of REQ<x> is passed to its corresponding output OUT<x>, while thereafter all successive (and wraparound, if any) ENABLE bits are kept low, as are the outputs of the blocks receiving those low ENABLE bits.

While Selector 10′ of FIG. 2 proves useful for demonstrating a prior art circular priority selector technique, it has several drawbacks. For example, there is a circular path of logic by the ENABLE bits through all of the 1-bit blocks. The path is a false path because it is only sensitized when all bits of REQ<19:0> equal 0. However, that circular path must be dealt with by timing verification and test generation tools, even though it is a false path. As another example, even if the circular path issues are considered, the logic delay of the ENABLE signal through selector 10′ is at least N (e.g., N=20) gates long, and it grows in direct proportion to the number of inputs. That delay may be too long or at least undesirable for some implementations.

As a result of the preceding, there arises a need to address the drawbacks of the prior art as is achieved by the preferred embodiments described below.

### BRIEF SUMMARY OF THE INVENTION

In one preferred embodiment, there is a circular priority selector, which comprises an input interface for receiving a first N-bit input and a second N-bit input. The selector also comprises a binary tree for searching in the first N-bit input to identify a location of a most significantly asserted value in the first N-bit input, wherein the searching commences at a location responsive to an asserted bit in the second N-bit. The selector also comprises circuitry, responsive to the binary tree, for outputting an output signal indicating a location of the most significantly asserted value in the first N-bit input.

Other aspects are also disclosed and claimed.

### BRIEF DESCRIPTION OF THE SEVERAL VIEWS OF THE DRAWING

FIG. 1 illustrates a schematic of two one-bit blocks implementing a portion of a prior art circular priority selector.

FIG. 2 illustrates a block diagram of a prior art circular priority selector with a total of N blocks 10₀ through 10_{N-1}.

FIG. 3 illustrates a general circuit 20 that depicts a logic function to provide an ENABLE output bit, EN_{OUT1}, based on the values of the ENABLE input bit, EN_{IN}, as well as one set of bits consisting of a generate and propagate bit

FIG. 4 illustrates a circular priority selector according to the preferred embodiments as including a two-part logic tree.

FIG. 5 illustrates a logic circuit 40 that connects two circuits in succession, both in the form of circuit 20 of FIG. 3, so as to produce an enable bit output, EN_{OUT2}, based on the value of two bits of each type, that is, with two generate and two propagate bits.

FIG. 6 illustrates a logic tree cell basic building block.

FIG. 7 illustrates binary tree 34 of FIG. 4 in greater detail.

FIG. 8 illustrates binary tree 34 of FIG. 7, along with some additional enable-merge cells implementing a stage S₅ and that form a portion of secondary logic tree 36 of logic tree 30 shown in FIG. 4.

FIG. 9 illustrates a portion of binary tree 34 of FIG. 8, along with some additional enable-merge cells of secondary logic tree 36, now illustrating a stage S₆, which in this preferred embodiment is a final stage for providing the ENABLE bits to AND gates 32₀ through 32_{N-1}=32₁₉ in FIG. 4.

FIG. 10A illustrates block 50 of FIG. 6 in the form of a positive logic block.

FIG. 10B illustrates block 50 of FIG. 6 in the form of a negative logic block

FIG. 11 again illustrates two-part logic tree 30 and incorporating various additional aspects.

FIG. 12A illustrates a logical function with respect to the positive logic outputs of the stage S₅ even bit outputs from the 20-bit-influenced and 22-bit-influenced enable-merge cells in FIG. 11.

FIG. 12B illustrates a first logical function with respect to the negative logic outputs of the stage S₆ odd bit outputs from the 21-bit-influenced and 23-bit-influenced enable-merge cells in FIG. 11.

FIG. 12C illustrates a second logical function with respect to the negative logic outputs of the stage S₆ odd bit outputs from the 21-bit-influenced and 23-bit-influenced enable-merge cells in FIG. 11.

FIG. 13 illustrates a 4-bit slice of an alternative to the implementation of FIG. 11.

FIG. 14 illustrates an implementation that has seven logic inversions.

FIG. 15 illustrates an alternative implementation that also has seven logic inversions.

FIG. 16 illustrates a generalized approach to make a 28-bit selector.

FIG. 17 illustrates a generalized approach to the alternative implementation of FIG. 15.

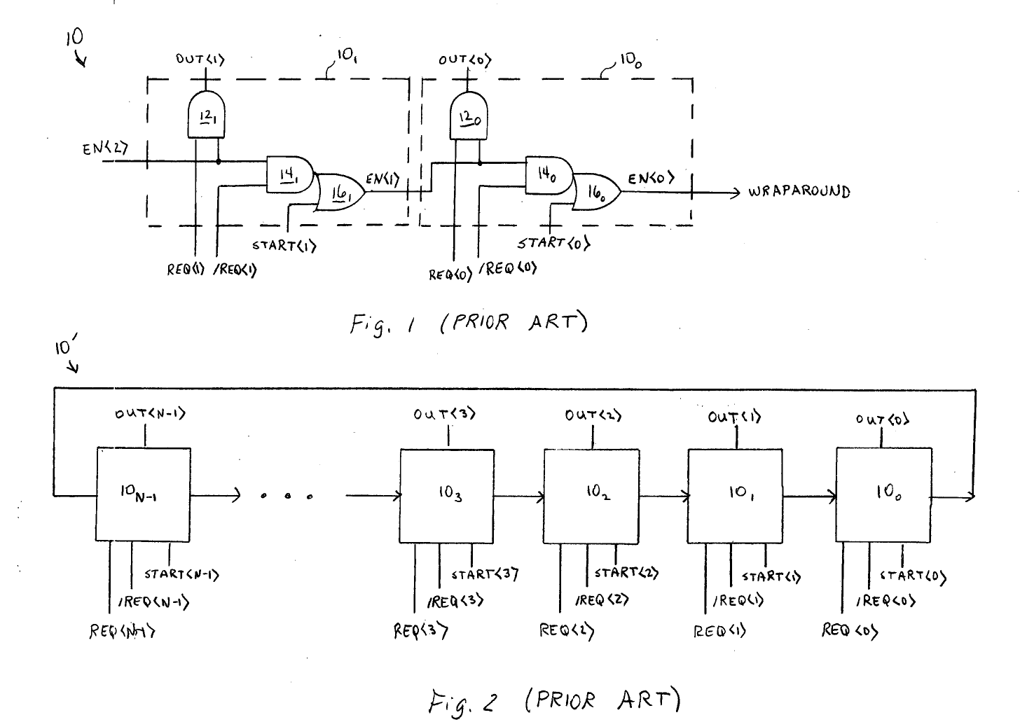

### DETAILED DESCRIPTION OF THE INVENTION

The present invention pertains to a circular priority selector which, as introduced in the Background Of The Invention section of this document, receives a first N-bit input (e.g., REQ) and then, based on an asserted value in a second N-bit input (e.g., START) locates a most significantly located value of one in the first input and outputs it as part of an N-bit output. Such a selector may be included in numerous electronic circuits and devices, where the first N-bit input may represent various requesting signals or entities. Particular choices of such circuits, devices, and signals or entities are ascertainable by one skilled in the art and are not intended to be limiting to the present inventive scope.

By way of introduction to the preferred embodiments, and assuming the reader is familiar with the principles also described in the Background Of The Invention section of this document, the present inventor has recognized that the ENABLE signal needed as part of the operation of a circular priority selector may be characterized in a particular manner. Specifically, the ENABLE signal is either: (1) generated by a given block in response to its START input; or (2) it is propagated onward by a block when it was generated in a preceding block, in the sense of the counterclockwise direction of the circular connectivity, and the block receiving an asserted ENABLE has a low. REQUEST input. With these observations, and in an effort to introduce some novel aspects of the preferred embodiments and various details developed later, the present inventor brings to the attention of a person with knowledge of an adder that instance (1) may be compared in some respects to an add carry generate, and instance (2) may be compared in some respects to an add carry propagate. Thus, in an effort to describe the preferred embodiments, the concepts of generate and propagate are helpful in that they correspond in some respects to the control of the ENABLE signal of the preferred embodiments, where a bit of that signal is either generated (e.g., asserted high) by a block or propagated by a block after a preceding block (either immediately preceding or otherwise) generated it. However, it is also noted that there are numerous differences as between a circular priority selector and an adder. For example, an adder has different inputs, performs different functionality by summing its inputs, does not operate in a circular manner, and its carry is generated or propagated from its least significant bit (“LSB”) toward its most significant bit (“MSB”).

With the above introduction of the nature of the ENABLE bit for a given block either being generated or propagated, the present inventor has determined that to either generate or propagate an ENABLE bit, such functions may be achieved logically in terms comparable in some respects to an adder's carry-merge circuit, and to facilitate such a logical implementation the START and REQUEST (or its complement, /REQUEST) signals may be used as shown in the following Equations 1a and 1b:
g_{—}1b<i>=START<i> Equation 1a
p_{—}1b<i>=/REQ<i> Equation 1b
In Equation 1a, the convention “g_{—}1b” is intended to indicate a generate (i.e., “g”) in response to an asserted one bit (i.e., “1b”) in START, and similarly in Equation 1b, the convention “p_{—}1b” is intended to indicate a propagate (i.e., “p”) in response to an asserted one bit (i.e., again, “1b”) in the complement of REQUEST.

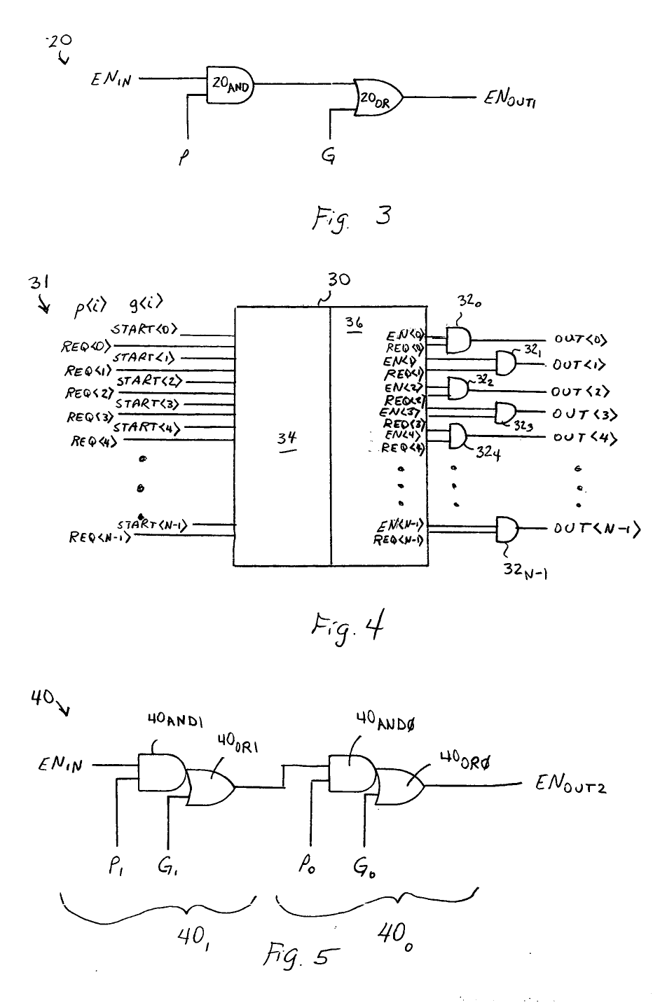

With an appreciation of the definitions set forth in Equations 1a and 1b and the notions of generate and propagate, note now by way of introduction and as further detailed below, the preferred embodiments implement a binary tree to process the START and REQUEST bits so as ultimately to produce ENABLE bits in a manner that does not require them to propagate through each individual block in the N total blocks as shown with respect to selector 10′ of FIG. 2. Toward this end, adjacent bit positions of the one-bit definitions of Equations 1a and 1b may be combined to form a multiple bit result in what win be referred to herein as an enable-merge circuit, where this term is used as a comparison to a carry-merge circuit in the adder art, which is used in its field for add generate and propagates. The development of the preferred embodiment enable-merge circuit is thus described below in connection with many of the remaining Figures.

FIG. 3 illustrates a general circuit 20 that depicts a logic function to provide an ENABLE output bit, EN_{OUT1}, based on the values of the ENABLE input bit, EN_{IN}, as well as one set of bits consisting of a generate and propagate bit (and which, as shown above, in the preferred embodiments are defined by Equations 1a and 1b). In FIG. 3, an AND gate 20_{AND} receives as inputs EN_{IN} and a propagate signal, P. The output of AND gate 20_{AND} is connected as an input to an OR gate 20_{OR}, which receives as another input a generate signal, G. The output of OR gate 20_{OR} provides an ENABLE EN_{OUT1} signal. The configuration of circuit 20 therefore indicates that EN_{OUT1} is asserted in one of two instances, which are consistent with the generate and propagate concepts. In a first instance, the preceding enable, EN_{IN} is asserted, and propagate P is also asserted, thereby indicating that the asserted EN_{IN} should be propagated onward in the form of asserting EN_{OUT1}. In a second instance, generate G is asserted, thereby indicating that the generated enable should be output in the form of asserting EN_{OUT1}. Accordingly, this two-instance functionality may be written in logic form as in the following Equation 1c:
EN_{OUT1}=P·EN_{IN}+G Equation 1c

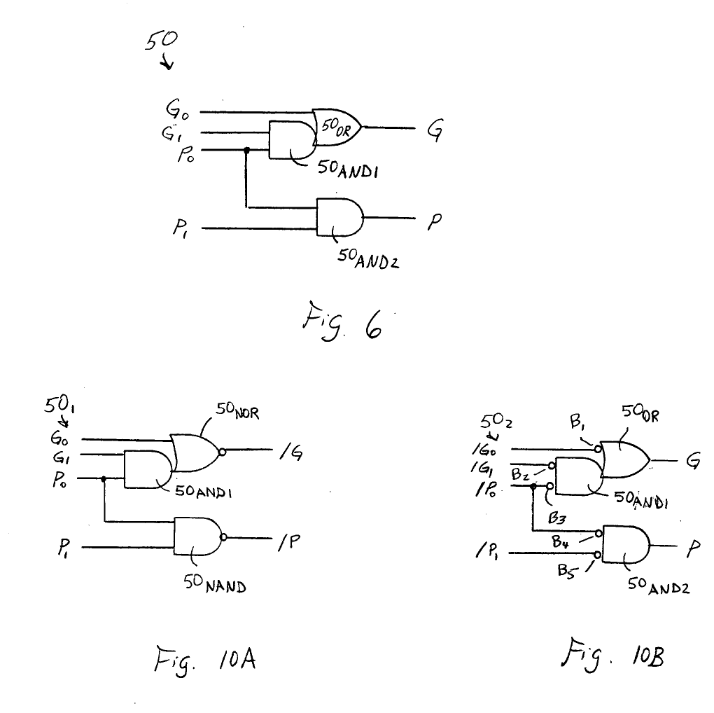

While Equation 1c and circuit 20 demonstrate the generation of an asserted EN_{OUT1} or the propagation of EN_{IN} to EN_{OUT1}, the preferred embodiments endeavor to develop the relationship of those signals in a manner that permits different outputs to be more readily affected without waiting for an enable signal to propagate across numerous blocks as was the case in FIG. 2. Toward this end and according to the preferred embodiments, various logic is developed, as demonstrated below, so as to use each set of two adjacent bits of each input signal (i.e., a propagate and a generate bit) to pass through what is introduced now in FIG. 4 as a two-part logic tree 30. In general, logic tree 30 includes the input side of a preferred embodiment circular priority selector 31 and, therefore, it provides the interface to receive the same input signals as that of circular priority selector 10′ of FIG. 2; however, to simplify FIG. 4, the REQUEST signal is not shown since its complement, /REQUEST, is shown. In addition, selector 31 includes N AND gates 32₀ through 32_{N-1}, each of which provides a respective OUTPUT bit OUT<0> through OUT<N−1>, where each of those AND gates receives as inputs a respective REQUEST signal bit REQ<0> through REQ<N−1> and a respective ENABLE signal bit EN<0> through EN<N−1>. However, as further detailed below, for each AND gate 32ₓ, its ENABLE input bit is not provided by a one-to-one correspondence of logic associated with a single block as shown in FIG. 2 and propagating serially in a chain, but instead the ENABLE bits are derived by logic tree 30.

In the preferred embodiment, a first part of logic tree 30 is a binary tree 34, which is not shown in detail at this point but is developed in much greater detail later. At this point by way of introduction, note that in binary tree 34, for each cell at each stage S of that tree, there are two bits, of the same signal type (e.g., generate as one type, propagate as one type) input to the cell. Moreover, for each bit-type output by a cell, be it either generate or propagate, the value of that bit is influenced by what originated as 2^{S} 1-bit signals of the same type. For example, in stage S₁ of binary tree 34, and for each cell at that stage, there are two propagate bits as inputs and two generate bits as inputs. Moreover, the output of that cell is influenced by the state of the input generate bits, which are influenced by 2 (i.e., 2^{S}=2¹=2) 1-bit signals as well as the state of the propagate bits, which also are influenced by 2 (i.e., 2^{S}=2¹=2) 1-bit signals. For this reason, in this document, the stage S₁ cells are referred to as 2-bit-influenced cells. As another example, in stage 2 of binary tree 34, and for each cell at that stage, again there are two inputs bits of each type, consisting of two propagate bits and two generate bits; however, since this is stage S₂, then the output of the stage S₂ cell is influenced by the state of the generate bits, which are influenced by 4 (i.e., 2^{S}=2²=4) 1-bit signals, as well as the state of the propagate bits, which also are influenced by 4 (i.e., 2^{S}=2²=4) 1-bit signals. For this reason, in this document, the stage S₁ cells are referred to as 4-bit-influenced cells. As a final example, in stage S₃ of binary tree 34, and for each cell at that stage, again there are two inputs bits of each type, consisting of two propagate bits and two generate bits; however, since this is stage S₃, then the outputs of each of its cells are influenced by the state of the generate bits, which are influenced by 8 (i.e., 2^{S}=2³=8) 1-bit signals, as well as the stage of the propagate bits, which also are influenced by 8 (i.e., 2^{S}=2³=8) 1-bit signals. For this reason, in this document, the stage S₃ cells are referred to as 8-bit-influenced cells. Other cells and the different number of bits of a single type that influence the cell's output also use this naming convention in this document. In any event, these aspects are further illustrated in greater detail, later.

Completing FIG. 4, a second part of logic tree 30, shown as a secondary logic tree 36, is optional, and proves useful if the ultimate number N of output bits for the ENABLE signal is not an integer power of two. For example, recall above that an example is introduced where N=20; in this case, that value of N is not an integer power of two and, hence, in addition to binary tree 34, a secondary logic tree 36 is included and uses inputs from the binary tree outputs to ultimately provide the needed 20 bits for the ENABLE signal that is connected to AND gates 32₀ through 32_{N-1}. Each of these aspects is detailed below.

Having described in connection with FIG. 3 the generating or propagating an asserted EN_{OUT1} output based on a single generate and single propagate input (as well as the EN_{IN} signal), FIG. 5 illustrates a logic circuit 40 that connects two circuits in succession, both in the form of circuit 20 of FIG. 3, so as to produce an enable bit output, EN_{OUT2}, based on the value of two bits of each type, that is, with two generate and two propagate bits. A first section 40₁ of circuit 40 includes an AND gate 40_{AND1} that receives as inputs EN_{IN} and a propagate bit, P₁, and the output of AND gate 40_{AND1} is connected as an input to an OR gate 40_{OR1}, which receives as another input a generate signal, G₁. The output of OR gate 40_{OR1} is connected to a second section 40₀ of circuit 40 and more particularly as an input to an AND gate 40_{AND0} that also receives as an input a propagate bit, P₀. The output of AND gate 40_{AND0} is connected as an input to an OR gate 40_{OR0}, which receives as another input a generate signal, G₀. Note that the use of “0,” in subscripts for section 40₀ as compared to the use of “1” in subscripts for section 40₁ is intended to reflect the directionality of the ENABLE bit in the preferred embodiment circular priority selector from higher toward lower significant bit position (e.g., shown as left to right in this and other figures). The output of OR gate 40_{OR0} provides the EN_{OUT2} signal.

The logical results produced by circuit 40 for EN_{OUT2} are now described, based on when circuit 40 will itself generate an asserted value of EN_{OUT2} or when it will propagate an asserted value of EN_{IN}. First, with respect to circuit 40 generating an asserted value of EN_{OUT2} (i.e., without an assertion of EN_{IN}), such an event may be described by the following Equation 1d:
generate EN_{OUT2}=G₀+P₀·G₁ Equation 1d
Second, with respect to circuit 40 propagating an asserted value of EN_{IN} to its output EN_{OUT2}, such an event may be described by the following Equation 1e:
propagate asserted EN_{IN} to EN_{OUT2}=P₀·P₁ Equation 1e
Accordingly, Equations 1d and 1e should demonstrate to one skilled in the art that the two bits of different types input to circuit 20 of FIG. 3 may be repeated two form a circuit 40 of FIG. 5 that receives twice as many of these bits, where the latter can either generate an asserted output or provide an asserted output by propagating an asserted input. Importantly for understanding later concepts, note with respect to the circuit 40 inputs that one set of two bits of differing types (e.g., P₁ and G₁) is from a first bit position in the input bits, while the other set of two bits of differing types (e.g., P₀ and G₀) is from a second bit position, in the inputs, that is adjacent to the first bit position.

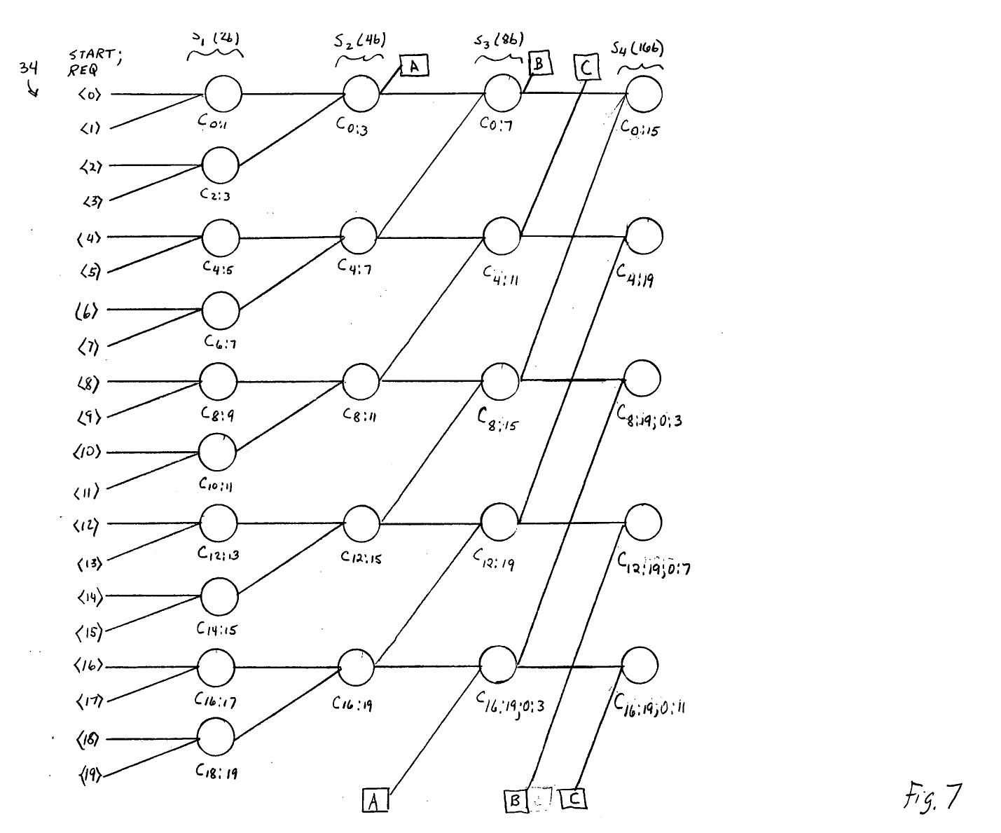

From the preceding, note that Equation 1d provides a generate-type signal that may be used for another replication of circuit 40 and Equation 1e provides a propagate-type signal that also may be used for that replication of circuit 40. Accordingly, those Equations may be represented by a basic building block 50, which is shown in FIG. 6. Block 50 includes an OR gate 50_{OR} that receives G₀ as one input and its other input is connected to the output of an AND gate 50_{AND1}. AND gate 50_{AND1} receives G₁ and P₀ as inputs, and OR gate 50_{OR} produces a generate signal, G, at its output. Block 50 also includes an AND gate 50_{AND2}, which receives P₀ and P₁ as its inputs and produces a propagate signal, P, at its output. From these connections, one skilled in the art will appreciate that block 50 realizes the logic of Equations 1d and 1e. Thus, this logic also demonstrates how two sets of bits, corresponding to differing bit positions (e.g., one set with P₁ and G₁ at a bit position <1> and one set with P₀ and G₀ at bit position <0>), may be used together to provide both a generate and propagate output signal. The use of these adjacent input bit positions (e.g., positions 0 and 1) to create a single generate and a single propagate output may be referred to herein as merging the states of the higher bit position bits with the states of the lower bit position bits via the logic of block 50 and, thus, further demonstrates the earlier introduction of the terminology of enable-merge circuit as that term will be used throughout this document.

With the preceding observations, note that the relationship of input bits to output bits of block 50 also may be stated according to the following Equations 1f and 1g:
g_{—}2b<i>=g_{—}1b<i>+p_{—}1b<i>g_{—}1b<i+1> Equation 1f
p_{—}2b<i>=p_{—}1b<i>p_{—}1b<i+1> Equation 1g

In Equations 1f and 1g, <i> represent an index to a given bit and, thus, <i+1> is that index incremented to thereby indicate a next adjacent bit in the input bits defined by Equations 1a and 1b. The outputs, g_{—}2b<i> and p_{—}2b<i>, represent generate and propagate signals, respectively, that are influenced by the state of two bits of the same type; thus, the value of g_{—}2b is influenced by the state of two different generate bits (as well as a propagate bit) and the value of p_{—}2b is influenced by the state of two different propagate bits. Here, however, and in contrast to arithmetic carry chains, inputs to carries at bit <i> come from a bit at position <i> and a position <i+1> that is more significant than bit <i>, rather than at and of less significance, such as the output of an adder at bit <i> that is affected by bits of less significance.

The preceding demonstrates a foundation from which binary tree 34, introduced as part of two-part logic tree 30 in FIG. 4, may be developed further, as is now discussed in connection with FIG. 7. Specifically, FIG. 7 illustrates binary tree 34 in greater detail, and for the example where the N-bit inputs are 20 bit signals (i.e., N=20). Vertically and to the left of FIG. 7 are shown the two input signals START<0:19> and REQ<0:19>. In general, binary tree 34 includes four binary stages, S₁, S₂, S₃, and S₄. Each stage is shown, in a vertical direction, to include a number of cells C_{x:y}, shown as circles, where each circle is preferably implemented with the functionality of basic building block 50 of FIG. 6, thereby receiving two 1-bit inputs of each input type (i.e., generate and propagate)—thus, as further appreciated below, each cell operates to perform an enable-merge function. Each cell is designated with the letter “C” and an x:y subscript (i.e. C_{x:y}), where x is the least significant bit position and y is the most significant bit position of the bits whose state have an influence on the two output bits of the respective stage. For example, in stage S₁, there is a cell C_{0:1}, having an output therefore influenced by the state of the generate bits at positions 0 and 1 and the propagate bits at positions 0 and 1. As another example, in stage S₁, there is a cell C_{0:3}, having an output therefore influenced by the state of the generate bits at positions 0 through 3 and the propagate bits at positions 0 thorough 3, where this influence as well as the remaining examples will be further appreciated below.

The structure and operation of binary tree 34 of FIG. 7 is now further explained, by way of a first example of traces through various connections. By tracing a horizontal path starting from input bit positions 0 and 1, the lines from those positions indicate inputs to cell C_{0:1}, intending to demonstrate that the generate (i.e., START) bits at positions 0 and 1 are inputs to cell C_{0:1} and the propagate (i.e., /REQ) bits at positions 0 and 1 also are inputs to cell C_{0:1}. As stated above, each cell takes the functional form of block 50 from FIG. 6 and, thus, these four bits are connected as inputs in the manner shown in FIG. 6. Moreover, the outputs of cell C_{0:1} therefore provide a single generate and a single propagate signal, also consistent with FIG. 6. As further appreciated later, since only signals from bit positions 0 and 1 are input to cell C_{0:1} with no other like-type preceding signals, then only those signals influence the cell C_{0:1} output, which is contrasted later with subsequent cells that have outputs influenced by additional like-type bits.

As another example of the structure and operation of binary tree 34, now tracing a horizontal path starting from input bit positions 2 and 3, the lines from those positions indicate inputs to cell C_{2:3}, intending to demonstrate that the generate (i.e., START) bits at positions 2 and 3 are inputs to cell C_{2:3} and the propagate (i.e., /REQ) bits at positions 2 and 3 also are inputs to cell C_{2:3}, again which functions as a enable-merge block 50 from FIG. 6. Accordingly, the outputs of cell C_{2:3} provide a single generate and a single propagate signal. Continuing to the right in FIG. 7, note that the the outputs of cell C_{2:3} are connected as inputs to (i.e., merged in) with the outputs of cell C_{0:1} into a stage S₂ cell, namely, cell C_{0:3}. Thus, the generate and the propagate bit from cell C_{0:1} and the generate and the propagate bit from cell C_{2:3} are all inputs to cell C_{0:3}. Note then, as now discussed and as shown by the tree structure in FIG. 7, that the outputs of cell C_{0:3} are influenced by the states of the generate (i.e., START) bits from all of bit positions 0 through 3 and the propagate (i.e., /REQ) bits from all of bit positions 0 through 3, as those bits are processed through stage S₁ to stage S₂. This pattern continues for the entirety of the tree structure. Accordingly and by way of an additional example, in stage S₃, cell C_{0:7} receives as inputs the generate and propagate output of each of cell C_{0:3} and cell C_{4:7}; thus, the outputs of cell C_{0:7} are influenced by the states of the generate (i.e., START) bits from all of bit positions 0 through 7 and the propagate (i.e., /REQ) bits from all of bit positions 0 through 7, as those bits are processed through stage S₁, stage S₂, and stage S₃.

As yet another example of the structure and operation of binary tree 34, consider now that bits 8 through 15 trace in a comparable manner to bits 0 through 7, described above. Specifically, the propagate bits at positions 8 and 9 and the generate bits at positions 8 and 9 are input to a stage S₁ cell C_{8:9}, and the propagate bits at positions 10 and 11 and the generate bits at positions 10 and 11 are input to a stage S₁ cell C_{10:11}. Similarly, the propagate and generate bits at positions 12 and 13 are input to a stage S₁ cell C_{12:13}, and the propagate and generate bits at positions 14 and 15 are input to a stage S₁ cell C_{14:15}. The outputs of each of cells Q_{8:9} and C_{10:11} are connected as inputs to a stage S₂ cell C_{8:11}, and the outputs of each of cells C_{l2:13} and C_{12:15} are connected as inputs to a stage S₂ cell C_{12:15}. Thus, the outputs of stage S₂ cell C_{8:11} are influenced by the propagate and generate bits from positions 8 through 11, and the outputs of stage S₂ cell C_{12:15} are influenced by the propagate and generate bits from positions 12 through 15. The outputs of cells C_{8:11} and C_{12:15} are connected to stage S₃ cell C_{0:15}. Now, combining this example with one from above, the outputs of stage S₃ cell C_{0:7}, and the outputs of stage S₃ cell C_{8:15} are all connected as inputs to stage S₄ cell C_{0:15}. Accordingly, the outputs of cell C_{0:15} are influenced by 16 propagate and 16 generate bits, from positions 0 through 15. Lastly, one skilled in the art will appreciate comparable connectivity in the remaining areas of binary tree 34, with boxes A, B, and C also shown to indicate various wraparound connectivity within the structure.

Various observations are now helpful with respect to binary tree 34 of FIG. 7. The illustration demonstrates how five enable outputs are produced by five respective stage S₄ cells, one occurring for every set of four adjacent input positions, where each such output is influenced by 16 of the N=20 input bits. Additional discussion below demonstrates how the outputs are further processed by secondary logic tree 36 so that they properly reflect the entirety of the N=20 input bits. However, if additional outputs were desired based on the present approach of binary tree 34, then one skilled in the art will appreciate that portions or all of binary tree 34 could be replicated so as to accommodate a number of outputs equal to an integer power of two, and those outputs could be used to directly drive AND gates 32₀ through 32_{N-1} in FIG. 4. As another observation, note that the 2-bit-influenced enable outputs are produced every other bit (the even bits, 0, 2, 4, and so forth) using START as the generate input and /REQ as the propagate input. Five 4-bit-influenced bit enables are produced in the respective cells of second stage S₂, one for every four bits (bits 0, 4, 8, 12 and 16), using the 2-bit-influenced enable outputs as their inputs. Likewise, five 8-bit-influenced enable outputs are produced in the respective cells of stage S₃, using the 4-bit-influenced enable outputs as their inputs, and five 16-bit-influenced enable outputs are produced in the respective cells of stage S₄, using the outputs of the 8-bit-influenced enables. Thus, it takes four stages of logic to produce 16-bit-influenced enable signals. Note that some inputs to cell C_{16:19,0:3} (i.e., the 8-bit-influenced enable-merge cell at bit position 16), as also shown via the boxed A, wrap around from the outputs of cell C_{0:3} (i.e., bit position 0 4-bit-influenced enable outputs); to illustrate this connectivity, the subscript of that cell indicates the bits of higher bit position followed by the wraparound bits of lower bit position, and this convention is also used elsewhere in the remainder of this document. Likewise, some inputs to the 16-bit-influenced cell C_{11:9,0:7} at bit position 12 and cell C_{16:19,0:11} at bit position 16 also wrap around. The wraparound produces symmetry, namely, each 4-bit slice of the diagram is identical to all others. Lastly, note that whereas in an adder as its carry groups get larger, fewer and fewer carries are sometimes produced (like in a carry-select or conditional sum adder), in contrast in the preferred embodiments the 16-bit-influenced enables are produced every four bits, because ultimately every output bit is controlled by one of these 16-bit-influenced outputs.

Binary tree 34 also provides a basis to understand various relationships of the inputs/outputs in the different stages of cells as the number of bits influencing an output increases. Specifically, from the preceding, one skilled in the art may now appreciate that the stage S₂ logic cells can be represented as shown in the following Equations 2a and 2b:
g_{—}4b<i>=g_{—}2b<i>+p_{—}2b<i>g_{—}2b<i+2> Equation 2a
p_{—}4b<i>=p_{—}2b<i>p_{—}2b<i+2> Equation 2b
Thus, in Equations 2a and 2b and as shown in FIG. 7, the inputs to a 4-bit-influenced cell (i.e., g_{—}4b or p_{—}4b) are output by 2-bit-influenced cells corresponding to bit positions <i> and <i+2>. Likewise, 8-bit-influenced and 16-bit-influenced enables may be generated in the stages S₃ and S₄, as shown in FIG. 7 and as represented by the following Equations 3a, 3b, 4a, and 4b:
g_{—}8b<i>=g_{—}4b<i>+p_{—}4b<i>g_{—}4b<i+4> Equation 3a
p_{—}8b<i>=p_{—}4b<i>p_{—}4b<i+4> Equation 3b
g_{—}16b<i>=g_{—}8b<i>+p_{—}8b<i>g_{—}8b<i+8> Equation 4a
p_{—}16b<i>=p_{—}8b<i>p_{—}8b<i+8> Equation 4b
Further, as with other instances demonstrated above, note that when adding bit indices, the result in the preferred embodiment is taken modulo(20). For example, if i=16, then i+8=24 becomes bit 4 mod 20.

Having discussed binary tree 34 of FIG. 7 in detail, note that the preceding Equations may be summarized in a more general fashion and also consistent with the earlier definition of a binary tree. In this regard, note in FIG. 7 that two input bits of a same signal type are input to each enable-merge cell, but FIG. 6 shows that these two enable bits, whether of the propagate type or the generate type, are not interchangeable. The Equations above and FIG. 7 show that the bit index on the output is the same as the bit index on one of the inputs. For this input, it will be referred to herein as the base bit input, at a position<i>, and is input as G₀ and P₀ of FIG. 6. The other input will be referred to herein as the merged input, which is input as G₁ and P₁ of FIG. 6. Thus, in FIG. 7, the base bit input comes into a cell horizontally, whereas the merged bit comes into a cell along a diagonal from a different bit position. Note that at each stage, there is a specific offset between the base bit position and the merged bit position. The offset is the width of the base bit input, that is, it is equal to the number of bits that influence the base bit input. For example, in Equations 1f and 1g, the base bit inputs are g_{—}1b<i> and p_{—}1b<i>, both being one bit wide enable signals. The offset of the merge bit is therefore 1 bit, and the merge inputs are g_{—}1b<i+1> and p_{—}1b<i+1>. Similarly, in Equations 2a and 2b, the base inputs are g_{—}2b<i> and p_{—}2b<i>, both two bits wide, so the offset of the merge bit is 2, and the merge inputs are g_{—}2b<i+2> and p_{—}2b<i+2>. Thus, one skilled in the art will appreciate that the offset is 4 for Equations 3a and 3b, and it is 8 for Equations 4a and 4b.

Given the preceding, then for any generate output of a number NR bits and for any propagate output of the number NR bits, that output may be written in terms of its inputs as shown in the following Equations 5a and 5b:
g_{—NRb<i>=g}_(NR/2)b<i>+p_(NR/2)b<i>g_(NR/2)b<i+(NR/2)> Equation 5a
p_{—}NRb<i>=p_(NR/2)b<i>p_(NR/2)b<i+(NR/2)> Equation 5b
Equation 5a demonstrates that an NR-bit generate output from an enable-merge block 50 is responsive to either a generate from a cell in an immediately preceding stage at the same base bit position OR a propagate from the cell in an immediately preceding stage at the same base bit position AND'ed with a generate from a cell in an immediately preceding stage and that is from a merge position of bits that is shifted by NR/2. Also, Equation 5b demonstrates that an NR-bit propagate output from an enable-merge block 50 is responsive to a propagate from the cell in an immediately preceding stage at the same base bit position AND'ed with a propagate from a cell in an immediately preceding stage and that is from a merge position of bits that is shifted by NR/2.

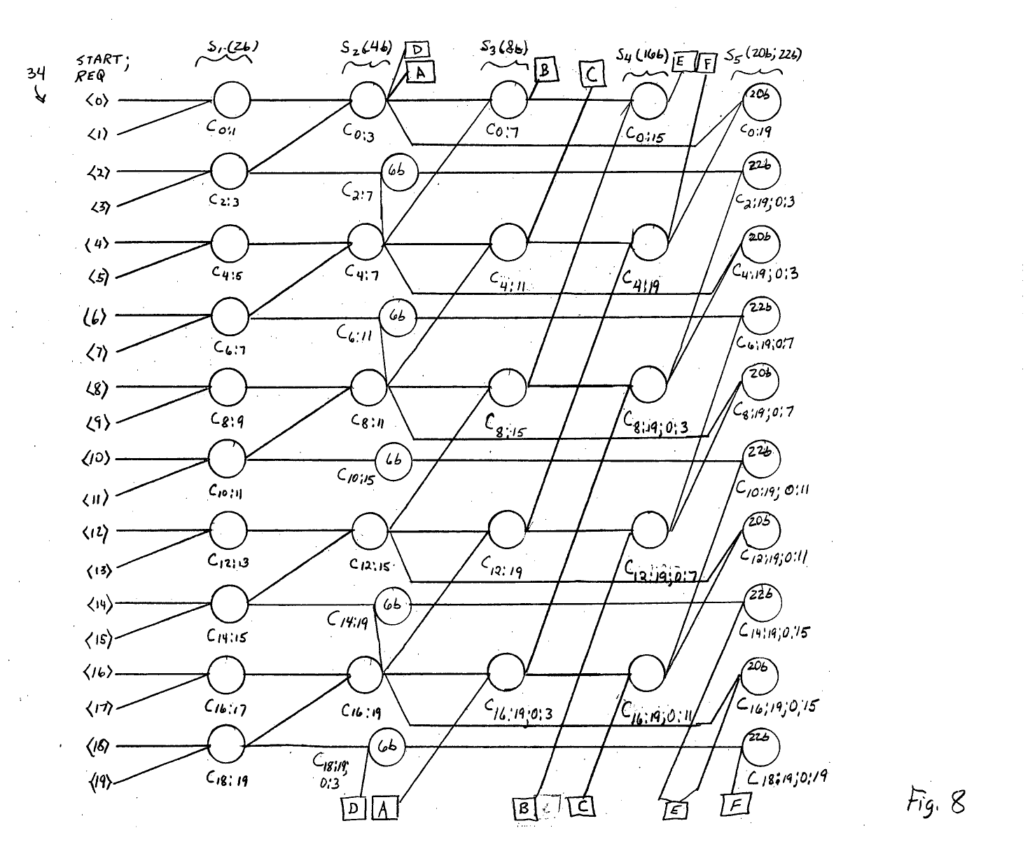

FIG. 8 illustrates binary tree 34 of FIG. 7, along with some additional enable-merge cells implementing a stage S₅ and that form a portion of secondary logic tree 36 of logic tree 30 shown in FIG. 4. By way of example and tracing across from bit position 4, cell C_{4:19;0:3} provides a 20-bit-influenced enable-merge cell by merging the enable output of both a 4-bit-influenced cell C_{4:7} and a 16-bit-influenced cell C_{8:19;0:3} to produce a 20-bit-influenced enable. While at stage S₅ a 32-bit-influenced bit enable could be generated by merging the outputs of two 16-bit-influenced cells, in the present example the circular priority selector operates with respect to N=20 bit inputs, so that is the minimum number of influencing input bits. Also by way of example and tracing across from bit position 2, cell C_{2:19;0:3} is what is referred to herein as a 22-bit-influenced enable-merge cell because its outputs are affected by the states of the outputs that total a number of 22 bits, which here are provided by base bits output of a 6-bit-influenced cell C_{2:7} and the merge bits output by a 16-bit-influenced cell C_{8:19;0:3}, where the 6-bit-influenced enable produced by cell C_{2:7} is in turn produced by an enable-merge circuit getting its inputs from a 2-bit-influenced cell C_{2:3} and a 4-bit-influenced cell C_{4:7}. Note that the enable signal from cell C_{2:19,0:3} is described as a 22-bit-influenced enable, even though the implementation is only 20 bits wide. The extra two bits are actually false path logic because, as shown by the subscript to cell C_{2:19;0:3}, bit positions 2 and 3 are disabled by any asserted START bit between it and the base bit that is 21 bits away; thus, the implementation is still correct, and referring to these signals as 22-bit enables is a useful labeling technique. When these three cells, the 6-bit-influenced enable, the 20-bit-influenced enable, and the 22-bit-influenced enable are repeated every four bits (a total of five times), at the output there is either a 20-bit-influenced enable or a 22-bit-influenced enable every two bits (the even bits). This fifth stage S₅ of logic performs two functions: it provides the next larger enable group (at least 20 bits rather than 16), and it produces outputs twice as densely as the previous stage (once every two bits rather than every four bits). This is a step along the way to ultimately produce an output for every N=20 input bit. The logic equations for these three cells, namely, 6-, 20-, and 22-bit-influenced cells, shown by example as cells C_{2:7}, C_{4:19,0:3}, and C_{2:19;0:3}, are listed as Equations 6a and 6b, 7a and 7b, and 8a and 8b, respectively, below.
g_{—}20b<i>=g_{—}4b<i>+p_{—}4b<i>g_{—}16b<i+4> Equation 6a
p_{—}20b<i>=p_{—}4b<i>p_{—}16b<i+4> Equation 6b
g_{—}6b<i>=g_{—}2b<i>+p_{—}2b<i>g_{—}4b<i+2> Equation 7a
p_{—}6b<i>=p_{—}2b<i>p_{—}4b<i+2> Equation 7b
g_{—}22b<i>=g_{—}6b<i>+p_{—}6b<i>g_{—}16b<i+6> Equation 8a
p_{—}22b<i>=p_{—}6b<i>p_{—}16b<i+6> Equation 8b
In view of the preceding, for the 20-bit-influenced enable equations of Equations 6a and 6b, the base inputs are 4 bits wide (g_{—}4b<i> and p_{—}4b<i>) and the offset of the merge bits is 4. For the 6-bit-influenced enable equations of Equations 7a and 7b, the base inputs are 2 bits wide (g_{—}2b<i> and p_{—}2b<i>) and the offset of the merge bits is 2. Lastly, for the 22-bit-influenced enable equations of Equations 8a and 8b, the base inputs are 6 bits wide (g_{—}6b<i> and p_{—}6b<i>) and the offset of the merge bits is 6.

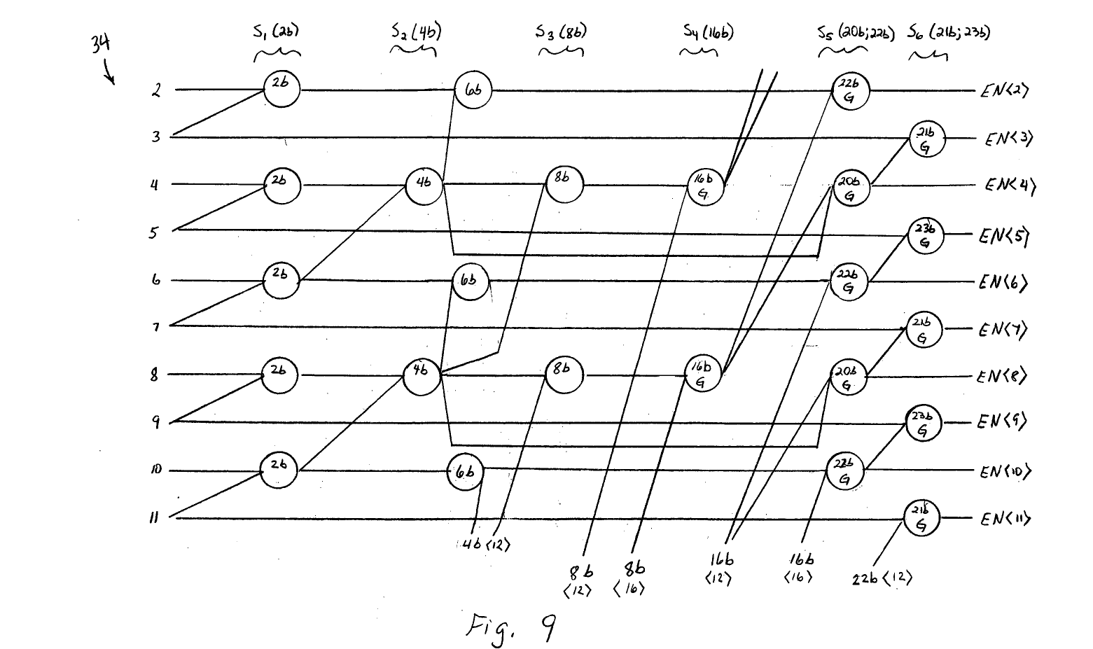

FIG. 9 illustrates a portion of binary tree 34 of FIG. 8, along with some additional enable-merge cells of secondary logic tree 36, now illustrating a stage S₆, which in this preferred embodiment is a final stage for providing the ENABLE bits to AND gates 32₀ through 32_{N-1}=32₁₉ in FIG. 4; for sake of simplifying the drawing, only a portion of binary tree 34 is shown, while one skilled in the art should appreciate that the aspects now explained in connection with FIG. 9 may be symmetrically repeated throughout the entirety of binary tree 34 and secondary logic tree 36. In addition, a convention is also illustrated in FIG. 9 and in later Figures whereby for those signal paths that reach beyond the illustrated bit positions, those are understood to be repeated symmetrically and to further show such connectivity in some instances the number of merge input bits (e.g., 4b for 4 bits) are shown as is the bit position location of the cell from which the merge input comes (e.g., <12> represents a cell at big position 12). Turning then to FIG. 9 in detail, the 20-bit-influenced and 22-bit-influenced enable-merge cells each actually have, or are influenced by, the enable information from every input bit, so for their bit positions they provide each final ENABLE output bit EN<i> to the input of a respective AND gate 32ᵢ. But, as discussed above in connection with FIG. 8, such outputs exist only on the even bit positions. Accordingly, in FIG. 9, additional enable-merge cells, shown as stage S₆ cells, are placed along the horizontal traces of the odd bit positions. For example, looking along the horizontal trace of bit position 3, it connects to a 21-bit-influenced cell which is designated as C_{3;4:19;0:3}, where the first “3” in the subscript is to indicate the influence from the generate and propagate values at base bit position 3 as indicated by the horizontal trace across that position, while the remaining numbers in the subscript indicate the other bit values influencing the outputs of that cell, which as shown by the remainder of the subscript wrap back around to bit position 3; in other words, because this cell is a 21-bit-influenced cell, and since N=20, then the wraparound causes the generate and propagate values at bit position 3 again to be false logic because they are disabled by any asserted START bit between it and the more than 20-bit away base bit. As another example, looking along the horizontal trace of bit position 5, it connects as an input to a 23-bit-influenced cell which is designated as C_{5;6:19;0:7}, where the “5” in the subscript is to indicate the influence from the generate and propagate values at base bit position 5 as indicated by the horizontal trace, while the remaining numbers in the subscript indicate the other bit values influencing the outputs of that cell, which as shown by the remainder of the subscript wrap back around to bit position 7; in other words, because this cell is a 23-bit-influenced cell, and since N=20, then the wraparound causes the generate and propagate values at bit positions 5, 6, and 7 to be likewise disabled by an asserted START bit.

The equations for the 21-bit-influenced cells and 23-bit-influenced cells in FIG. 9 are:
g_{—}21b<i>=g_{—}1b<i>+p_{—}1b<i>g_{—}20b<i+1> Equation 9a
p_{—}21b<i>=p_{—}b<i>p_{—}20b<i+1> Equation 9b
g_{—}23b<i>=g_{—}1b<i>+p_{—}b<i>g_{—}22b<i+1> Equation 10a
p_{—}23b<i>=p_{—}b<i>p_{—}22b<i+1> Equation 10b
Moreover, these Equations may be generalized for both the 21 and 23-bit instances, in terms of a number of bits exceeding 20, shown as NR₂₀₊, as follows:
g_{—}NR₂₀₊b<i>=g_{—}1b<i>+p_{—}1b<i>g_(NR₂₀₊−1)b<i+1> Equation 11a
p_{—}NR₂₀₊b<i>=p_{—}1b<i>p_(NR₂₀₊−1)b<i+1> Equation 11b
Thus, for either the 21-bit-influenced enable Equation 11a or the 23-bit-influenced enable Equation 11b, the base inputs are 1 bit wide (g_{—}1b<i> and p_{—}1b<i>) and the offset of the merge bits is 1.

According to a preferred embodiment, an additional optimization is made with respect to certain selected cells as pertaining to the output signals they provide, thereby simplifying the number of gates and signals versus that required by block 50 of FIG. 6. In one aspect in this regard, it is noted that the final output cell of stage S₆ for coupling an input to a respective one of AND gates 32₀ through 32_{N-1} (e.g., 32₁₉) is only required to produce a single output signal to provide the enable function, and this signal may be solely the generate signal rather than the propagate signal as there is no next stage to further propagate an enable provided by a stage S₆ cell; thus, the propagate output signal from these cells can be eliminated. This is done in all stage S₆ cells, that is, the 21-bit-influenced and 23-bit-influenced cells. Returning briefly to FIG. 6, it can be seen that this eliminates the need for the P₁ input, which is the Pₓ signal from the merged bit input (although the P₀ bit, that is, the propagate base bit, is still required). With this observation, note also from FIG. 9 that the propagate output of the 20-bit-influenced and 22-bit-influenced enable-merge cells of stage S₅ is only ever used as the merge input to stage S₆ enable-merge cells, which now have been shown not to require the Pₓ merge input. Therefore, the Pₓ output of these stage S₅ cells is also not needed and can be eliminated. Similarly, from FIG. 8 it may be seen that the 16-bit-influenced cell outputs from stage S₄ only ever function as the merge bit inputs to the stage S₅ 20-bit-influenced and 22-bit-influenced enable-merge cells, which also as shown above do not require a Pₓ merge input signal; thus, the Pₓ output on the stage S₄ cells also may be eliminated. In view of the preceding, the first three stages S₁, S₂, and S₃ of cells need to produce both Gₓ and Pₓ outputs, whereas the final three stages S₄, S₅, and S₆, of cells need only produce the Gₓ output; to illustrate this aspect in FIG. 9, those latter cells are labeled with a G inside the circular indication of each such cell.

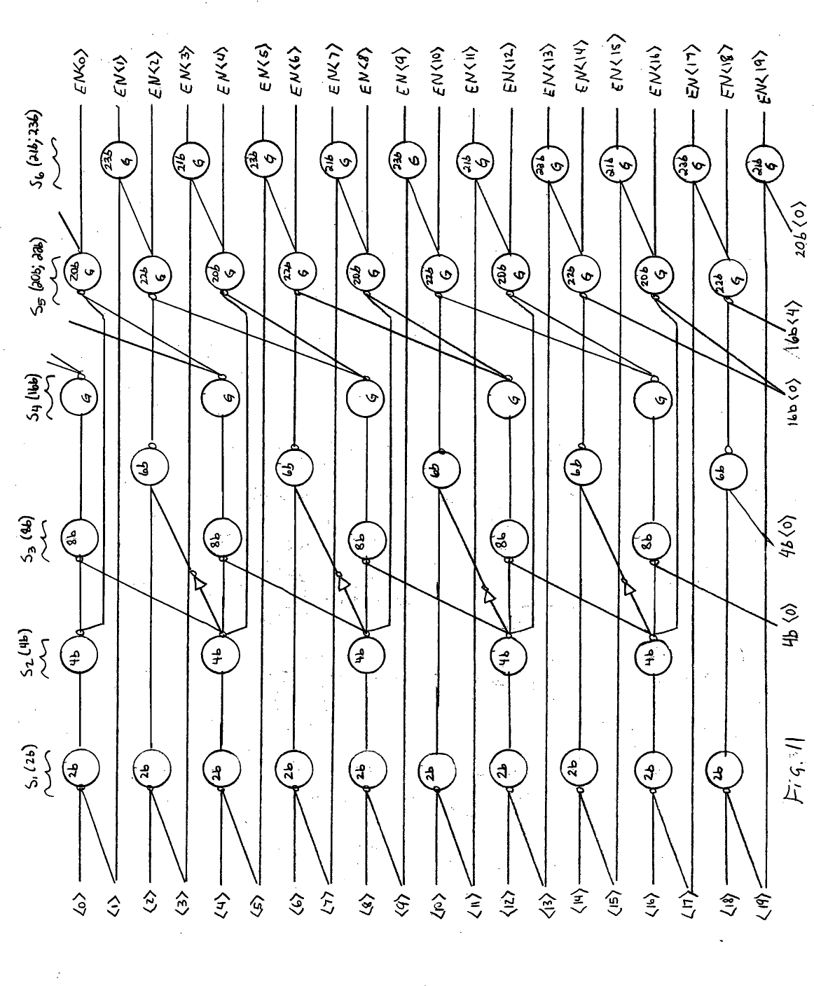

In the preferred embodiment, an additional implementation aspect is to make each stage Sₓ of cells inverting so that its logic can be implemented in a single gate and, thus, the polarity of each cell in a stage will alternate relative to the preceding and/or following stage. Toward this end, FIGS. 10A and 10B illustrate block 50 of FIG. 6 in the form of a positive logic block 50₁ and a negative logic block 50₂, respectively. One skilled in the art should readily appreciate the comparable connectivity and operation of these blocks relative to block 50 and, a brief review is presented here. Turning then to block 50₁ of FIG. 10A, it includes the same positive inputs as block 50 of FIG. 6, although the outputs are inverted by including a NOR gate 50_{NOR} and a N_{AND} gate 50_{NAND} in place of, respectively, OR gate 50_{OR} and AND gate 50_{AND2} in block 50 of FIG. 6. Thus, the outputs of block 50₁ are inverted, thereby providing /G and /P. Looking to block 50₂ of FIG. 10B, it is constructed to receive the inverted outputs from blocks of the type of block 50₁ of FIG. 10A. Thus, inverters are provided to each input signal, shown by way of bubbles B₁, B₂, B₃, B₄, and B₅, for each of the inputs /G₀, /G₁, /P₀, and /P₁. Thus, the outputs of block 50₂ are the positive logic signals for inputting to a cell in the form of block 50₁ of FIG. 10A.

FIG. 11 again illustrates two-part logic tree 30 from above, and incorporating various additional aspects. In FIG. 11, the 2-bit-influenced enable-merge cells are in stage S₁, 4 bit-influenced cells are in stage S₂, 8-bit-influenced cells are in stage S₃, 16-bit-influenced cells are in stage S₄, 20-bit-influenced and 22-bit-influenced cells are in stage S₅, and 21-bit-influenced and 23-bit-influenced cells are in stage S₆. The enable-merge blocks in stages S₄ through S₆ have a G inside the circular indication of each such cell to indicate that they only produce the generate output. Each carry-merge cell symbol also now has a bubble on either its input or output, representing which interface is negative polarity. For example, the 6-bit-influenced enable-merge cells have negative logic outputs to drive the 22-bit-influenced cells. Also, therefore, the input signals of the 6-bit-influenced cells are positive logic. This is compatible with its inputs from the 2-bit-influenced cells, but not from the 4-bit-influenced block. Accordingly, inverters INVₓ are also shown connected to the output of each 4 bit-influenced cell as it connects to the input of a 6-bit-influenced cell, where the subscript x for each such inverter denotes the base bit position of the input to the respective inverter.

While FIG. 11 illustrates one approach to embodying various of the above-described principles, note further that alterations are permitted thereto that provide redundant inputs and, therefore, permit different connectivity. For example, recall in FIG. 8 it is shown that the 20-bit-influenced cell outputs are produced by an enable-merge of a 4-bit-influenced base input with a 16-bit-influenced merge input. However, instead of the 4-bit-influenced input at that bit position, the 8-bit-influenced cell or 16-bit-influenced cell, either at that same base bit position as the 4-bit-influenced cell, could be used as an input to the 20-bit-influenced cell. While the input cone of logic of an 8-bit-influenced input would overlap with that of a 16-bit-influenced input only 4 bits away, the overlap creates redundancy but not incorrectness. This example demonstrates therefore a possible alternative because in some circumstances it may be desirable to use alternative inputs from among the choice of legal inputs. As another example, when each stage is made of inverting logic, and the polarity of the stages of output signals are alternating, then getting an input from a different stage can eliminate the need for the addition of inverters. An example is taken from FIG. 11, where the 6-bit-influenced enable-merge cells require input inverters where each gets its inputs from the 4-bit-influenced cell outputs. As an alternative, each 6-bit-influenced enable-merge cell could get its merge-bit input from the 8-bit-influenced enable-merge cell at the same bit position as the merge-bit 4-bit-influenced cell, since the 8-bit-influenced enable-merge cell has the desired positive output polarity. This would technically make the 6-bit-influenced cell have the functionality of a 10-bit-influenced cell, but when it is merged with the 16-bit-influenced enable at the 6 bits offset, the extra 4 bits (difference between the original 6-bit-influenced cell and the new 10-bit-influenced cell) become redundant.

Also in FIG. 11, notice that the stage S₅ even bit outputs from the 20-bit-influenced and 22-bit-influenced enable-merge cells are positive polarity, while the stage S₆ odd bit outputs from the 21-bit-influenced and 23-bit-influenced enable-merge cells are negative polarity. Though of alternating polarity, these 20 outputs form the ENABLE output signal shown in FIG. 4.

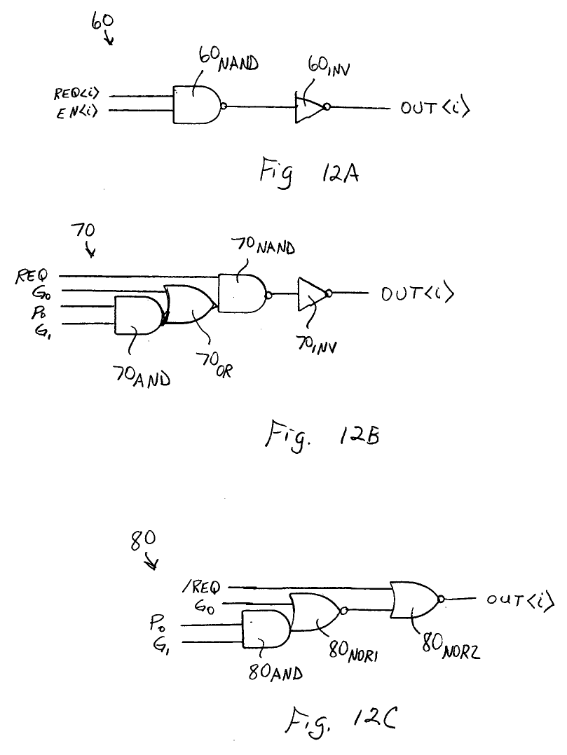

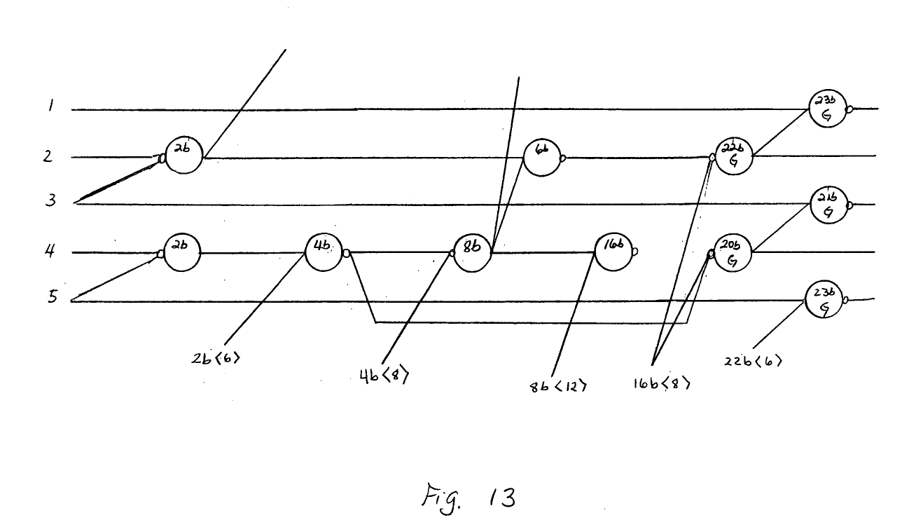

With respect to the positive logic outputs of the stage S₅ even bit outputs from the 20-bit-influenced and 22-bit-influenced enable-merge cells in FIG. 11, in the preferred embodiment they are AND'ed with the REQ signal to produce the priority encoder output, as shown in FIG. 12A. In this regard, FIG. 12A implements this logical function as a N_{AND} gate 60_{NAND} that receives REQ<i> and EN<i> at its inputs, and with its output connected through an inverter 60_{INV} to produce a corresponding OUT<i> output. The use of a NAND gate 60_{NAND} followed by an inverter 60_{INV} to implement the logical AND is to parallel that discussed in FIGS. 12B and 12C below with respect to the remaining outputs.

With respect to the negative logic outputs of the stage S₆ even bit outputs from the 21-bit-influenced and 23-bit-influenced enable-merge cells in FIG. 11, in the preferred embodiment they are implemented in one of two manners that also incorporate the last needed function of AND'ing with an appropriate REQUEST signal bit, where the two different approaches are shown respectively in FIGS. 12B and 12C. Looking to FIG. 12B, the G₁ merge bit (i.e., from the output of a 20-bit-influenced or 22-bit-influenced enable-merge) is input to an AND gate 70_{AND}, which also receives as an input the base bit P₀. The output of AND gate 70_{AND} provides one input to an OR gate 70_{OR}, which also receives as an input the base bit G₀. The output of OR gate 70_{OR} is connected as an input to a N_{AND} gate 70_{NAND}, which also receives as an input the corresponding base bit REQUEST bit, REQ<i>. The output of N_{AND} gate 70_{NAND} is connected through an inverter 70_{INV} to provide the output bit, OUT<i>. Note that inverter 70_{INV} provides a positive polarity output with good load driving capability. Looking to FIG. 12C, the G₁ merge bit (i.e., from the output of a 20-bit-influenced or 22-bit-influenced enable-merge) is input to an AND gate 80_{AND}, which also receives as an input the base bit P₀. The output of AND gate 80_{AND} provides one input to a NOR gate 80_{NOR1}, which also receives as an input the base bit G₀. The output of NOR gate 80_{NOR1} is connected as an input to a NOR gate 80_{NOR2}, which also receives as an input the corresponding base bit REQUEST bit, in complement form, /REQ<i>. The output of NOR gate 80_{NOR2} provides a positive polarity output, OUT<i>. By comparing FIG. 12C with block 50 of FIG. 6, and ignoring the AND gate 50_{AND2} from block 50 because the merge propagate bit is not needed in FIG. 12 for reasons discussed earlier, then one skilled in the art may appreciate that the FIG. 12C approach uses a NOR gate to AND in the ENABLE to the REQ signal, where the REQ signal therefore has to be negative logic (i.e., /REQ).

The implementation of FIG. 11 has a total of eight logic inversions of delay. The first inversion is that required to produce the 1-bit-influenced propagate signals, which are equal to /REQ. Then there are six enable-merge blocks with one inversion each. The stage S₆ carry-merge blocks are implemented by the approach of either FIG. 12B or 12C to combine in the /REQ term. This costs a final inversion, either from output inverter 70_{INV} of FIG. 12B or NOR gate 80_{NOR} of 12C. The odd bits have this architecture, while the even bits output the ENABLE from the stage S₅ enable-merge cells, thereby causing one less level of gate delay to the ENABLE output For even bits, there are six inversions through the 20-bit-influenced or 22-bit-influenced outputs, plus two more for the final AND'ing of FIG. 12A.

Under alternative preferred embodiments, there are several other implementations that trade gate count for reduced latency. When discussing alternative options, 4-bit slices of the architectures are presented, since each 4-bit slice is identical to all the others. A 4-bit slice of an alternative to the implementation of FIG. 11 is shown in FIG. 13. The FIG. 13 approach uses the option discussed above, where each 6-bit-influenced enable-merge cell gets its input from an 8-bit-influenced cell instead of a 4-bit-influenced cell in order to eliminate some inverters. In all the alternatives, several of the enable-merge cells remain invariant. These include (for each 4-bit-influenced cell) two 2-bit-influenced cells, as well as the 4-bit-influenced, 8-bit-influenced, 16-bit-influenced, and 20-bit-influenced blocks. Generally, the tradeoffs in performance versus cost involve choosing different ways to get the 16-bit-influenced enable information that is only present once every four bits fanned out to four adjacent output bits, the way to merge in the last four bits into the enable, and the way to get the output for the odd bits.

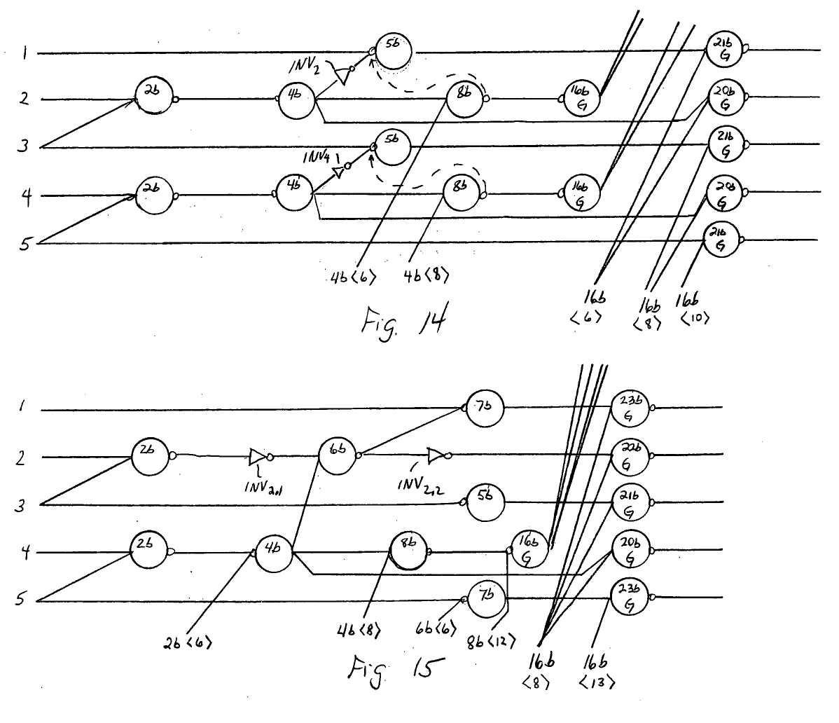

An implementation that has seven logic inversions, one less than previously described, is shown in FIG. 14. The FIG. 14 implementation has 2-bit-influenced, 4-bit-influenced, 8-bit-influenced, 16-bit-influenced, and 20-bit-influenced enable-merge cells, all located every two bits instead of every four bits as was the case in the above-described implementation. The odd bit positions require 21-bit enables, so a 5-bit-influenced enable is generated once every two bits and output as an input into the 21-bit-influenced enable cells. By generating the 5-bit-influenced enable earlier, the circuit can go from 16 bits to 21 bits in one gate delay rather than the two gate delays of the previous implementation. Here, the 5-bit-influenced enable requires negative logic inputs, whereas the 4-bit-influenced output is positive logic. So the 5-bit-influenced input could be taken from the 8-bit-influenced output, as shown by dashed arrows, rather than the 4-bit-influenced output to eliminate inverters INV₂, INV₄, and so forth. Note in FIG. 14 that many of the connections to the enable-merge blocks remain the same as the previous implementation, but have been left out of the figure for clarity. The one inversion of reduced latency in FIG. 14 comes at a cost; whereas the eight inversion delay implementation of FIG. 13 has 10 enable-merge cells per 4-bit slice, the FIG. 14 one has 14 such cells.

Another implementation with seven inversions of latency is shown in FIG. 15. Here, the 4-bit-influenced, 8-bit-influenced, and 16-bit-influenced enable-merge cells are once more only instantiated every 4 bit positions. This requires a 16-bit-influenced enable to be merged with 4-bit-influenced, 5-bit-influenced, 6-bit-influenced, and 7-bit-influenced enables in order to generate the final outputs for the four bit positions. So, in FIG. 15, 5-bit-influenced, 6-bit-influenced, and 7-bit-influenced enable-merge cells have been added to produce these signals ahead of time. While this implementation costs 12 enable-merge blocks per 4-bit slice, versus the 14 above, it adds some extra inverters not present in that design.

The preceding preferred embodiments may be generalized to circular priority selectors of different widths. As the width gets larger, the number of stages may have to increase. Every time the width is doubled, one more stage must be added, but other than the addition of a stage, the circuits look the same. For example, with one more stage of logic, the 20-bit implementation of FIG. 13 would become a 36-bit implementation (both implementations are for 2^{N+}4 bits wide). To produce an implementation of 2^{N}+C bits, where C varies, it is useful to observe how the connections to 20-bit-influenced and 22-bit-influenced cells of FIG. 13 can be changed. If the 4-bit-influenced input to the 20-bit-influenced cell came from an output of an 8-bit-influenced cell instead, and the offset of the 16-bit-influenced input were changed from 4 to 8 bits, the 20-bit-influenced cell output is now a 24-bit-influenced wide enable signal. Alternatively, its 4-bit-influenced input could be changed to the output of the 16-bit-influenced cell output and the offset of its 16-bit-influenced input changed from 4 bits to 16 bits. This makes the output have 32-bit functionality, although now that 16-bit-influenced outputs are used as base inputs to the next stage of cells, they require propagate outputs as well as generate outputs. In general, this can be done even if the actual design is still 20 bits wide. So, one skilled in the art may generalize the 20-bit output and the 21-bit output as well. This technique is all that is required to generalize the implementation of FIG. 14.

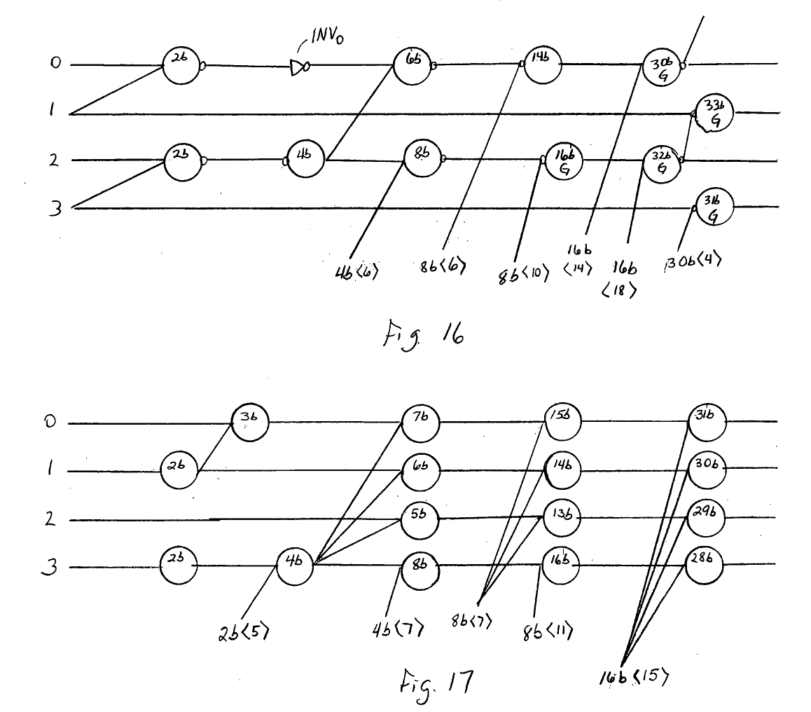

The 22-bit-influenced cell also may be generalized as is now explored. In FIG. 13, the 6-bit-influenced input had been reconnected from the 4-bit-influenced output to the 8-bit-influenced output in order to match signal polarities. This actually makes it a 10-bit-influenced signal, suitable for a 24-bit design when the 20-bit-influenced cell is also appropriately modified. To make a 28-bit selector, the 6-bit-influenced cell must become a 14-bit-influenced cell, as shown in FIG. 16. The 14-bit-influenced cell gets a 6-bit-influenced base input (which now must be generated one stage earlier) and an 8-bit-influenced merge input that is 6 bits offset. The 4-bit-influenced cell output is then used just like the 6-bit-influenced one was before.

The design of FIG. 15 also may be generalized as follows. Instead of 5-bit-influenced, 6-bit-influenced, and 7-bit-influenced functionality for a 20-bit design, for a 28-bit design these need to be 8 bits wider, thus, as 13-bit-influenced, 14-bit-influenced, and 15-bit-influenced. These require more enable-merge cells to pre-compute these signals in time to deliver them to the final stage of gates. FIG. 17 shows the implementation, though eventually it has enough enable-merge blocks that the architecture of FIG. 14 becomes less expensive.

From the above, it may be appreciated that the preferred embodiments provide a circular priority selector that implements a logic tree, where the logic tree includes a binary tree and optionally a secondary logic tree. The preferred embodiments provide various benefits as compared to the prior art. As one example of a benefit, gate delay is considerably improved over the prior art approach of having an enable signal propagate successively through each stage of the device. As another example of a benefit, the preferred embodiments scale to different widths of selectors. As another benefit, there is not a circular false path as exists in the prior art. Thus, the preferred embodiments include various aspects and advantages as compared to the prior art, and still others will be appreciated by one skilled in the art. Moreover, while the preferred embodiments have been shown by way of example, certain other alternatives have been provided and still others are contemplated. Thus, the preceding discussion and these examples should further demonstrate that while the present embodiments have been described in detail, various substitutions, modifications or alterations could be made to the descriptions set forth above without departing from the inventive scope which is defined by the following claims.

1. A circular priority selector, comprising:
an input interface for receiving a first N-bit input and a second N-bit input;
a binary tree for searching in the first N-bit input to identify a location of a most significantly asserted value in the first N-bit input, wherein the searching commences at a location responsive to an asserted bit in the second N-bit; and
circuitry, responsive to the binary tree, for outputting an output signal indicating a location of the most significantly asserted value in the first N-bit input.

2. The priority selector of claim 1 wherein N is an integer I power of two.

3. The priority selector of claim 2:
wherein the binary tree comprises the integer I stages of binary cells;
wherein for each binary cell at each stage S of the binary tree, two bits of a same signal type are input to the binary cell; and
wherein for each binary cell at each stage S of the binary tree, an output of the binary cell is influenced by what originated as 2^{S} 1-bit signals in the first N-bit input.

4. The priority selector of claim 1 and further comprising a logic tree;
wherein the binary tree comprises a plurality of binary tree cells;
wherein the logic tree comprises a plurality of logic tree cells;
wherein each cell in the plurality of logic tree cells has multiple inputs connected to outputs of selected ones of either or both a binary tree cell output or a logic tree cell output; and
wherein the logic tree outputs the output signal.

5. The priority selector of claim 4 wherein N is a number other than an integer power of two.

6. The priority selector of claim 4 wherein at least some of the plurality of binary tree cells and some of the plurality of logic tree cells comprise:
a first input for receiving a first base bit input of a first signal type and corresponding to a first bit position;
a second input for receiving a first merge bit input of the first signal type and corresponding to a second bit position, different than the first bit position;
a third input for receiving a second base bit input of a second signal type and corresponding to the first bit position;
a fourth input for receiving a second merge bit input of the second signal type and corresponding to the second bit position.

7. The priority selector of claim 6:
wherein the first bit position and the second bit position are bit positions in a logically circular set of bit positions; and
wherein the second bit position is one bit position away from the first bit position.

8. The priority selector of claim 7 wherein at least some of the plurality of binary tree cells and some of the plurality of logic tree cells further comprise:
a first logic AND function having a first AND input connected to the second input and a second AND input connected to the third input;
a logic OR function having a first OR input connected to the first input and a second OR input connected to an output of the first AND function; and
a second logic AND function having a first AND input connected to the third input and a second AND input connected to the fourth input.

9. The priority selector of claim 8:
wherein an output of the OR function comprises an output of the first signal type; and
wherein an output of the second AND function comprises an output of the second signal type.

10. The priority selector of claim 8 wherein each set of cells in each stage S of the binary tree provides a like type of output, the type of output selected from a positive logic output type and a negative logic output type.

11. The priority selector of claim 8 wherein, for each set of cells in a given stage of the binary tree, the cell provides a like type of output and is complementary to a type of output for a stage preceding either preceding or following the given stage.

12. The priority selector of claim 6 wherein at least some of the plurality of binary tree cells and some of the plurality of logic tree cells further comprise:
a first logic AND function having a first AND input connected to the second input and a second AND input connected to the third input;
a logic OR function having a first OR input connected to the first input and a second OR input connected to an output of the first AND function; and
a second logic AND function having a first AND input connected to the third input and a second AND input connected to the fourth input.

13. The priority selector of claim 12:
wherein an output of the OR function comprises an output of the first signal type; and
wherein an output of the second AND function comprises an output of the second signal type.

14. The priority selector of claim 12 wherein each set of cells in each stage S of the binary tree provides a like type of output, the type of output selected from a positive logic output type and a negative logic output type.

15. The priority selector of claim 12 wherein, for each set of cells in a given stage of the binary tree, the cell provides a like type of output and is complementary to a type of output for a stage preceding either preceding or following the given stage.

16. The priority selector of claim 15:
wherein the binary tree comprises the integer I stages of binary cells;
wherein for each binary cell at each stage S of the binary tree, where S is a power of two, two bits of a same signal type are input to the binary cell; and
wherein for each binary cell at each stage S of the binary tree, an output of the binary cell is influenced by what originated as 2^{S} 1-bit signals in the first N-bit input.

17. The priority selector of claim 6:
wherein the binary tree comprises the integer I stages of binary cells;
wherein for each binary cell at each stage S of the binary tree, where S is a power of two, two bits of a same signal type are input to the binary cell; and
wherein for each binary cell at each stage S of the binary tree, an output of the binary cell is influenced by what originated as 2^{S} 1-bit signals in the first N-bit input.

18. The priority selector of claim 4 wherein the binary tree and logic tree are symmetrically repeated for every four bits of the first N-bit input and the second N-bit input, and comprise:
a first bit position signal trace comprising a 2-bit-influenced cell, a 6-bit-influenced cell, and a 22-bit-influenced cell, wherein:
the 2-bit-influenced cell of the first bit position signal trace is responsive to a base input from the first bit position and a merge input that is offset by one bit position with respect to the first bit position;
the 6-bit-influenced cell of the first bit position signal trace is responsive to a 2-bit-influenced base input from an output of the 2-bit-influenced cell of the first bit position and a 4-bit-influenced merge input from a 4-bit-influenced cell that is offset by two bit positions with respect to the first bit position; and
the 22-bit-influenced cell of the first bit position signal trace is responsive to a 6-bit-influenced base input from an output of the 6-bit-influenced cell of the first bit position and a 16 bit-influenced merge input from a 16 bit-influenced cell that is offset by six bit positions with respect to the first bit position;
a second bit position signal trace comprising a 21-bit-influenced cell, wherein the 21-bit-influenced cell is responsive to a 1-bit-influenced base input from the second bit position and a 20-bit-influenced merge input from a 20-bit-influenced cell that is offset by one bit position with respect to the second bit position;
a third bit position signal trace comprising a 2-bit-influenced cell, a 4-bit-influenced cell, an 8-bit-influenced cell, and a 1-bit-influenced cell, the third bit position also having a corresponding output from a 20-bit-influenced cell, wherein:
the 2-bit-influenced cell of the third bit position signal trace is responsive to a base input from the third bit position and a merge input that is offset by one bit position with respect to the third bit position;
the 4-bit-influenced cell of the third bit position signal trace is responsive to a 2-bit-influenced base input from an output of the 2-bit-influenced cell of the third bit position and a 2-bit-influenced merge input from a 2-bit-influenced cell that is offset by two bit positions with respect to the third bit position;
the 8-bit-influenced cell of the third bit position signal trace is responsive to a 4-bit-influenced base input from an output of the 4-bit-influenced cell of the third bit position and a 4-bit-influenced merge input from a 4-bit-influenced cell that is offset by four bit positions with respect to the third bit position;
the 16-bit-influenced cell of the third bit position signal trace is responsive to an 8-bit-influenced base input from an output of the 8-bit-influenced cell of the third bit position and an 8-bit-influenced merge input from an 8-bit-influenced cell that is offset by eight bit positions with respect to the third bit position; and
the 20-bit-influenced cell of the third bit position signal trace is responsive to a 4-bit-influenced base input from an output of the 4-bit-influenced cell of the third bit position and an 16-bit-influenced merge input from a 16-bit-influenced cell that is offset by four bit positions with respect to the third bit position;
a fourth bit position signal trace comprising a 23-bit-influenced cell, wherein the 23-bit-influenced cell is responsive to a 1-bit-influenced base input from the fourth bit position and a 22-bit-influenced merge input from a 22-bit-influenced cell that is offset by one bit position with respect to the fourth bit position.

19. The priority selector of claim 18 and further comprising an inverter coupled between the 4-bit-influenced cell that is offset by two bit positions with respect to the first bit position and an input to the 6-bit-influenced cell of the first bit position signal trace.

20. The priority selector of claim 18 wherein, for each set of cells in a given stage of the binary tree and logic tree, the cell provides a like type of output and is complementary to a type of output for a stage either preceding or following the given stage.

21. The priority selector of claim 4 wherein the binary tree and logic tree are symmetrically repeated for every four bits of the first N-bit input and the second N-bit input, and comprise:
a first bit position signal trace comprising a 2-bit-influenced cell, a 6-bit-influenced cell, and a 22-bit-influenced cell, wherein:
the 2-bit-influenced cell of the first bit position signal trace is responsive to a base input from the first bit position and a merge input that is offset by one bit position with respect to the first bit position;
the 6-bit-influenced cell of the first bit position signal trace is responsive to a 2-bit-influenced base input from an output of the 2-bit-influenced cell of the first bit position and a 4-bit-influenced merge input from an 8-bit-influenced cell that is offset by two bit positions with respect to the first bit position; and
the 22-bit-influenced cell of the first bit position signal trace is responsive to a 6-bit-influenced base input from an output of the 6-bit-influenced cell of the first bit position and a 16-bit-influenced merge input from a 16-bit-influenced cell that is offset by six bit positions with respect to the first bit position;
a second bit position signal trace comprising a 21-bit-influenced cell, wherein the 21-bit-influenced cell is responsive to a 1-bit-influenced base input from the second bit position and a 20-bit-influenced merge input from a 20-bit-influenced cell that is offset by one bit position with respect to the second bit position;
a third bit position signal trace comprising a 2-bit-influenced cell, a 4 bit-influenced cell, an 8-bit-influenced cell, and a 16-bit-influenced cell, the third bit position also having a corresponding output from a 20-bit-influenced cell, wherein:
the 2-bit-influenced cell of the third bit position signal trace is responsive to a base input from the third bit position and a merge input that is offset by one bit position with respect to the third bit position;
the 4-bit-influenced cell of the third bit position signal trace is responsive to a 2-bit-influenced base input from an output of the 2-bit-influenced cell of the third bit position and a 2-bit-influenced merge input from a 2-bit-influenced cell that is offset by two bit positions with respect to the third bit position;
the 8-bit-influenced cell of the third bit position signal trace is responsive to a 4-bit-influenced base input from an output of the 4-bit-influenced cell of the third bit position and a 4-bit-influenced merge input from a 4-bit-influenced cell that is offset by four bit positions with respect to the third bit position;
the 16-bit-influenced cell of the third bit position signal trace is responsive to an 8-bit-influenced base input from an output of the 8-bit-influenced cell of the third bit position and an 8-bit-influenced merge input from an 8-bit-influenced cell that is offset by eight bit positions with respect to the third bit position; and
the 20-bit-influenced cell of the third bit position signal trace is responsive to a 4-bit-influenced base input from an output of the 4-bit-influenced cell of the third bit position and an 16-bit-influenced merge input from a 16-bit-influenced cell that is offset by four bit positions with respect to the third bit position;
a fourth bit position signal trace comprising a 23-bit-influenced cell, wherein the 23-bit-influenced cell is responsive to a 1-bit-influenced base input from the fourth bit position and a 22-bit-influenced merge input from a 22-bit-influenced cell that is offset by one bit position with respect to the fourth bit position.

22. The priority selector of claim 21 wherein, for each set of cells in a given stage of the binary tree and logic tree, the cell provides a like type of output and is complementary to a type of output for a stage preceding either preceding or following the given stage.

23. The priority selector of claim 4 wherein the binary tree and logic tree are symmetrically repeated for every two bits of the first N-bit input and the second N-bit input, and comprise:
a first bit position signal trace comprising a 5-bit-influenced cell and a 21-bit-influenced cell, wherein:
the 5-bit-influenced cell of the first bit position signal trace is responsive to a base input from the first bit position and a merge input from an output of a 4-bit-influenced cell of a signal trace of a second bit position that is offset by one bit position with respect to the first bit position; and
the 21-bit-influenced cell of the first bit position signal trace is responsive to a base input from an output of the 5-bit-influenced cell of the first bit position and a merge input from an output of a 16-bit-influenced cell that is offset by five bit positions with respect to the first bit position;
a second bit position signal trace comprising a 2-bit-influenced cell, a 4-bit-influenced cell, an bit-influenced cell, and a 16-bit-influenced cell, the third bit position also having a corresponding output from a 20-bit-influenced cell, wherein:
the 2-bit-influenced cell of the second bit position signal trace is responsive to a base input from the second bit position and a merge input offset by one bit position with respect to the second bit position;
the 4-bit-influenced cell of the second bit position signal trace is responsive to a 2-bit-influenced base input from an output of the 2-bit-influenced cell of the second bit position and a 2-bit-influenced merge input from a 2-bit-influenced cell that is offset by two bit positions with respect to the second bit position;
the 8-bit-influenced cell of the second bit position signal trace is responsive to a 4-bit-influenced base input from an output of the 4-bit-influenced cell of the second bit position and a 4-bit-influenced merge input from a 4-bit-influenced cell that is offset by four bit positions with respect to the second bit position;
the 16-bit-influenced cell of the second bit position signal trace is responsive to an 8-bit-influenced base input from an output of the 8-bit-influenced cell of the second bit position and an 8-bit-influenced merge input from an 8-bit-influenced cell that is offset by eight bit positions with respect to the second bit position; and
the 20-bit-influenced cell of the second bit position signal trace is responsive to a 4-bit-influenced base input from an output of the 4-bit-influenced cell of the second bit position and a 16-bit-influenced merge input from a 16-bit-influenced cell that is offset by four bit positions with respect to the second bit position.

24. The priority selector of claim 4 and further comprising an inverter coupled between the output of the 4-bit-influenced cell of the second bit position and the 5-bit-influenced cell of the first bit position.

25. The priority selector of claim 4 wherein the binary tree and logic tree are symmetrically repeated for every two bits of the first N-bit input and the second N-bit input, and comprise:
a first bit position signal trace comprising a 5-bit-influenced cell and a 21-bit-influenced cell, wherein:
the 5-bit-influenced cell of the first bit position signal trace is responsive to a base input from the first bit position and a merge input from an output of an 8-bit-influenced cell of a signal trace of a second bit position that is offset by one bit position with respect to the first bit position; and
the 21-bit-influenced cell of the first bit position signal trace is responsive to a base input from an output of the 5-bit-influenced cell of the first bit position and a merge input from an output of a 16-bit-influenced cell that is offset by five bit positions with respect to the first bit position;
a second bit position signal trace comprising a 2-bit-influenced cell, a 4-bit-influenced cell, an 8-bit-influenced cell, and a 16-bit-influenced cell, the third bit position also having a corresponding output from a 20-bit-influenced cell, wherein:
the 2-bit-influenced cell of the second bit position signal trace is responsive to a base input from the second bit position and a merge input offset by one bit position with respect to the second bit position;
the 4-bit-influenced cell of the second bit position signal trace is responsive to a 2-bit-influenced base input from an output of the 2-bit-influenced cell of the second bit position and a 2-bit-influenced merge input from a 2-bit-influenced cell that is offset by two bit positions with respect to the second bit position;
the 8-bit-influenced cell of the second bit position signal trace is responsive to a 4-bit-influenced base input from an output of the 4-bit-influenced cell of the second bit position and a 4-bit-influenced merge input from a 4-bit-influenced cell that is offset by four bit positions with respect to the second bit position;
the 16-bit-influenced cell of the second bit position signal trace is responsive to an 8-bit-influenced base input from an output of the 8-bit-influenced cell of the second bit position and an 8-bit-influenced merge input from an 8-bit-influenced cell that is offset by eight bit positions with respect to the second bit position; and
the 20-bit-influenced cell of the second bit position signal trace is responsive to a 4-bit-influenced base input from an output of the 4-bit-influenced cell of the second bit position and a 16-bit-influenced merge input from a 16-bit-influenced cell that is offset by four bit positions with respect to the second bit position.

26. The priority selector of claim 4 wherein the binary tree and logic tree are symmetrically repeated for every four bits of the first N-bit input and the second N-bit input, and comprise:
a first bit position signal trace comprising a 7-bit-influenced cell and a 23-bit-influenced cell, wherein:
the 7-bit-influenced cell of the first bit position signal trace is responsive to a base input from the first bit position and a merge input from a 6-bit-influenced cell that is offset by one bit position with respect to the first bit position; and
the 23-bit-influenced cell of the first bit position signal trace is responsive to a 7-bit-influenced base input from an output of the 7-bit-influenced cell of the first bit position and a 16-bit-influenced merge input from a 16-bit-influenced cell that is offset by seven bit positions with respect to the first bit position;
a second bit position signal trace comprising a 2-bit-influenced cell, a 6-bit-influenced cell, and a 22-bit-influenced cell, wherein:
the 2-bit-influenced cell of the second bit position signal trace is responsive to a base input from the second bit position and a merge input that is offset by one bit position with respect to the second bit position; and
the bit-influenced cell of the second bit position signal trace is responsive to a 2-bit-influenced base input from an output of the 2-bit-influenced cell of the second bit position and a 4-bit-influenced merge input from a 4-bit-influenced cell that is offset by two bit positions with respect to the second bit position; and
the 22-bit-influenced cell of the second bit position signal trace is responsive to a base input from an output of the 6-bit-influenced cell of the second bit position and a 16-bit-influenced merge input from a 16-bit-influenced cell that is offset by six bit positions with respect to the second bit position;
a third bit position signal trace comprising a 5-bit-influenced cell and a 21-bit-influenced cell, wherein:
the 5-bit-influenced cell of the third bit position signal trace is responsive to a base bit input from the third bit position and an 8-bit-influenced merge input from an 8-bit-influenced cell that is offset by one bit position with respect to the third bit position; and
the 21-bit-influenced cell of the third bit position signal trace is responsive to a 5-bit-influenced base input from an output of the 5-bit-influenced cell of the third bit position and a 16-bit-influenced merge input from a 16-bit-influenced cell that is offset by five bit positions with respect to the third bit position;
a fourth bit position signal trace comprising a 2-bit-influenced cell, a 4-bit-influenced cell, an 8-bit-influenced cell, and a 16-bit-influenced cell, the fourth bit position also having a corresponding output from a 20-bit-influenced cell, wherein:
the 2-bit-influenced cell of the fourth bit position signal trace is responsive to a base input from the fourth bit position and a merge input offset by one bit position with respect to the fourth bit position;
the 4-bit-influenced cell of the second bit position signal trace is responsive to a 2-bit-influenced base input from an output of the 2-bit-influenced cell of the fourth bit position and a 2-bit-influenced merge input from a 2-bit-influenced cell that is offset by two bit positions with respect to the fourth bit position;
the 8-bit-influenced cell of the fourth bit position signal trace is responsive to a 4-bit-influenced base input from an output of the 4-bit-influenced cell of the fourth bit position and a 4-bit-influenced merge input from a 4-bit-influenced cell that is offset by four bit positions with respect to the fourth bit position;
the 16-bit-influenced cell of the fourth bit position signal trace is responsive to an 8-bit-influenced base input from an output of the 8-bit-influenced cell of the fourth bit position and an 8-bit-influenced merge input from an 8-bit-influenced cell that is offset by eight bit positions with respect to the fourth bit position; and
the 20-bit-influenced cell of the fourth bit position signal trace is responsive to a 4-bit-influenced base input from an output of the 4-bit-influenced cell of the fourth bit position and a 16-bit-influenced merge input from a 16-bit-influenced cell that is offset by four bit positions with respect to the fourth bit position.

27. The priority selector of claim 4 wherein the binary tree and the logic tree comprise a plurality of signal traces, wherein each signal trace corresponds to a respective bit position and comprises at least one C-bit-influenced cell, the C-bit-influenced cell comprising:
a base bit input responsive to a B-bit signal from either the respective bit position or a cell corresponding to the respective bit position; and
a merge bit input from an M-bit-influenced cell that is offset by B bit positions with respect to the respective bit position.

28. The priority selector of claim 4 wherein the binary tree and the logic tree comprise a plurality of signal traces, wherein each signal trace corresponds to a respective bit position and comprises at least one C-bit-influenced cell, the C-bit-influenced cell comprising:
a base bit input responsive to a B-bit signal from either the respective bit position or a cell corresponding to the respective bit position; and
a merge bit input from an M-bit-influenced cell that is offset by F bit positions with respect to the respective bit position, wherein F is less than B.
